(19) United States
(12) Patent Application Publication
(10) Pub. No.: US 2017/0250431 A1
(43) Pub. Date: Aug. 31, 2017

(54) POLYMER SOLUTION, FIBER MAT, AND NANOFIBER MEMBRANE-ELECTRODE-ASSEMBLY THEREWITH, AND METHOD OF FABRICATING SAME

(71) Applicant: VANDERBILT UNIVERSITY, Nashville, TN (US)

(72) Inventors: Peter N. PINTAURO, Brentwood, TN (US); Wenjing ZHANG, Copenhagen (DK); Matthew BRODT, Nashville, TN (US); Andrew M. PARK, Nashville, TN (US); Jason B. BALLENGEE, Cedar Hill, TX (US); Ryszard WYCISK, Nashville, TN (US)

(21) Appl. No.: 15/511,709

(22) PCT Filed: Sep. 24, 2014
(86) PCT No.: PCT/US2014/057278

§ 371 Date: Mar. 16, 2017

Related U.S. Application Data
Application No. PCT/US14/57278 is a continuation-in-part of application No. 13/872,953, filed on Apr. 29, 2013, now Pat. No. 9,252,445.
Application No. 13/872,953 is a continuation-in-part of application No. 13/567,857, filed on Aug. 6, 2012, now Pat. No. 9,350,036.
Application No. 13/872,953 is a continuation-in-part of application No. 13/823,968, filed on Mar. 15, 2013.
Application No. PCT/US14/57278 is a continuation-in-part of application No. 13/823,968, filed on Mar. 15, 2013.
Application No. PCT/US14/57278 is a continuation-in-part of application No. 13/567,857, filed on Aug. 6, 2012, now Pat. No. 9,350,036.
(60) Provisional application No. 61/800,884, filed on Mar. 15, 2013.
(60) Provisional application No. 61/515,804, filed on Aug. 5, 2011.
(60) Provisional application No. 61/407,332, filed on Oct. 27, 2010.
(60) Provisional application No. 61/407,332, filed on Oct. 27, 2010.
(60) Provisional application No. 61/515,804, filed on Aug. 5, 2011.

(51) Int. Cl. H01M 8/1004; H01M 4/90; H01M 4/92; H01M 8/1065; H01M 4/86

(52) U.S. Cl. CPC H01M 8/1004; H01M 8/1065; H01M 4/8652; H01M 4/92; H01M 4/9041; H01M 2008/1095

(57) ABSTRACT

In one aspect of the present invention, a fiber mat is provided. The fiber mat includes at least one type of fibers, which includes one or more polymers. The fiber mat may be a single fiber mat which includes one type of fibers, or may be a dual or multi fiber mat which includes multiple types of fibers. The fibers may further include particles of a catalyst. The fiber mat may be used to form an electrode or a membrane. In a further aspect, a fuel cell membrane-electrode-assembly has an anode electrode, a cathode electrode, and a membrane disposed between the anode electrode and the cathode electrode. Each of the anode electrode, the cathode electrode and the membrane may be formed with a fiber mat.

### CROSS-REFERENCE TO RELATED PATENT APPLICATIONS

This PCT application is a continuation-in-part of U.S. patent application Ser. No. 13/872,953 (hereinafter the '953 Application), filed Apr. 29, 2013, entitled “NANOFIBER MEMBRANE-ELECTRODE-ASSEMBLY AND METHOD OF FABRICATING SAME,” by Peter N. Pintauro, Jason Ballengee and Matthew Brodt. The '953 Application claims priority to and the benefit of, pursuant to 35 U.S.C. §119(e), U.S. provisional patent application Ser. No. 61/800,884, filed Mar. 15, 2012, entitled “NANOFIBER MEMBRANE-ELECTRODE-ASSEMBLY AND METHOD OF FABRICATING SAME,” by Peter N. Pintauro, Jason Ballengee and Matthew Brodt. The '953 Application is also a continuation-in-part of U.S. patent application Ser. No. 13/567,857, filed Aug. 6, 2012, entitled “MEMBRANES, METHODS OF MAKING SAME, AND APPLICATIONS OF SAME,” by Peter N. Pintauro and Andrew Park, which itself claims priority to and the benefit of, pursuant to 35 U.S.C. §119(e), U.S. provisional patent application Ser. No. 61/515,804, filed Aug. 5, 2011, entitled “NANOFIBER/NANOCAPILLARY NETWORK PROTON EXCHANGE MEMBRANE, MAKING OF SAME, AND APPLICATIONS OF SAME,” by Peter N. Pintauro and Andrew Park. The '953 Application is also a continuation-in-part of U.S. patent application Ser. No. 13/823,968, filed Mar. 15, 2013, which is a U.S. national stage application under 35 U.S.C. §371 of PCT patent application Ser. No. PCT/US11/58088, filed Oct. 27, 2011, entitled “NANOFIBER ELECTRODE AND METHOD OF FORMING SAME,” by Peter N. Pintauro and Wenjing Zhang, which itself claims the benefit, pursuant to 35 U.S.C. §119(e), of U.S. provisional patent application Ser. No. 61/407,332, filed Oct. 27, 2010, entitled “NANOFIBER FUEL CELL ELECTRODE AND METHOD OF FORMING SAME,” by Peter N. Pintauro and Wenjing Zhang. All the above disclosures of the applications are incorporated herein in their entireties by reference.

This PCT application is also a continuation-in-part of U.S. patent application Ser. No. 13/823,968, filed Mar. 15, 2013, which is a U.S. national stage application under 35 U.S.C. §371 of PCT patent application Ser. No. PCT/US1158088, filed Oct. 27, 2011, entitled “NANOFIBER ELECTRODE AND METHOD OF FORMING SAME,” by Peter N. Pintauro and Wenjing Zhang, which itself claims the benefit, pursuant to 35 U.S.C. §119(e), of U.S. provisional patent application Ser. No. 61/407,332, filed Oct. 27, 2010, entitled “NANOFIBER FUEL CELL ELECTRODE AND METHOD OF FORMING SAME,” by Peter N. Pintauro and Wenjing Zhang, all the above disclosures of which are incorporated herein in their entireties by reference.

This PCT application is also a continuation-in-part of U.S. patent application Ser. No. 13/567,857, filed Aug. 6, 2012, entitled “MEMBRANES, METHODS OF MAKING SAME, AND APPLICATIONS OF SAME,” by Peter N. Pintauro and Andrew Park, which itself claims priority to and the benefit of, pursuant to 35 U.S.C. §119(e), U.S. provisional patent application Ser. No. 61/515,804, filed Aug. 5, 2011, entitled “NANOFIBER/NANOCAPILLARY NETWORK PROTON EXCHANGE MEMBRANE, MAKING OF SAME, AND APPLICATIONS OF SAME,” by Peter N. Pintauro and Andrew Park, all the above disclosures of which are incorporated herein in their entireties by reference.

Some references, which may include patents, patent applications and various publications, are cited and discussed in the description of this invention. The citation and/or discussion of such references is provided merely to clarify the description of the present invention and is not an admission that any such reference is “prior art” to the invention described herein. All references cited and discussed in this specification are incorporated herein by reference in their entireties and to the same extent as if each reference was individually incorporated by reference. In terms of notation, hereinafter, “[n]” represents the nth reference cited in the reference list. For example, [4] represents the 4th reference cited in the reference list, namely, J. B. Ballengee and P. N. Pintauro, Macromolecules, 44, 7307 (2011).

### STATEMENT OF FEDERALLY-SPONSORED RESEARCH

The invention was made with government support under Grant No. DE-FG36-06G016030 awarded by U.S. Department of Energy, Contract No. W911NF-11-1-0454 awarded by the Army Research Office, Grant No. CBET-1032948 awarded by the National Science Foundation, and Grant No. EPS-1004083 awarded by the National Science Foundation. The government has certain rights in the invention.

### FIELD OF THE INVENTION

The present invention relates generally to fuel cells, and more particularly, to a fuel cell membrane-electrode-assembly (MEA) having a membrane, an anode electrode and a cathode electrode, where at least one of the electrodes and the membrane is formed of electrospun fibers, a dual or multi fiber mat formed by the electrospun fibers, a polymer solution used to form the electrospun fibers, and methods of forming the same.

### BACKGROUND OF THE INVENTION

The background description provided herein is for the purpose of generally presenting the context of the present invention. Work of the presently named inventors, to the extent it is described in this background section, as well as aspects of the description that may not otherwise qualify as prior art at the time of filing, are neither expressly nor impliedly admitted as prior art against the present invention.

Fossil fuels are currently the predominant source of energy in the world. Due to concerns such as carbon dioxide emissions and the finite nature of the supply of fossil fuel, research and development and commercialization of alternative sources of energy have grown significantly over the past decades. One focus of research and development is hydrogen fuel cells, which can quietly and efficiently generate electrical power while producing only heat and water as significant byproducts.

One type of hydrogen fuel cells is a proton exchange membrane (PEM) fuel cell. A PEM is a membrane generally made from an ionomer and designed to conduct protons while being impermeable to gases such as oxygen or hydrogen. PEM fuel cells have the potential to replace internal combustion engines, the current dominant source of energy for motor vehicles and other such mobile propulsion applications, and is a promising candidate for emission-free automotive power plants due to its high power output, energy conversion efficiency, and quick start-up. At the anode electrode of a PEM fuel cell, hydrogen molecules are oxidized to hydrogen ions, i.e., protons, and electrons. The protons permeate across a polymer membrane that acts as an electrolyte (the PEM) while the electrons flow through an external circuit and produce electric power. At the cathode of a hydrogen/air fuel cell, oxygen reacts with electrons and protons that migrate across the PEM to produce water. Thus, in the past decade, the research and development has focused on the membrane composition and structure of the PEM and methods of forming the PEM, where the PEM structure is robust and the manufacturing process thereof is simplified.

Alkaline anion-exchange membrane fuel cells (AAEMFCs) are a potentially significant technology that could compete with the more popular and well-studied PEM fuel cells for a variety of applications [1]. The alkaline anion exchange membrane (AEM or AAEM) is a membrane generally made from ionomers with positively charged fixed ion-exchange sites and designed to conduct anions while being impermeable to gases such as oxygen or hydrogen. During alkaline fuel cell operation, the membrane conducts hydroxide ions. A fundamental drawback of all AEMs is the fact that hydroxide anions have a lower inherent mobility than protons which adversely affects ionic conduction in an AEM [2]. To compensate for this problem, membrane researchers have focused their attention on the use of high ion-exchange capacity polymers, but this strategy exacerbates the problems of membrane brittleness in the dry state and poor mechanical strength when the membrane is fully hydrated [3].

Additionally, most fuel cell electrodes are fabricated by a decal method or by catalyst-ink on a carbon paper gas diffusion layer (GDL). The platinum (Pt) catalyst utilization efficiency in such structures is not as high as desired. There has been little research conducted to improve electrode structures and methods of fabricating fuel cell membrane-electrode-assemblies with improved catalyst utilization.

Therefore, a heretofore unaddressed need exists in the art to address the aforementioned deficiencies and inadequacies.

### SUMMARY OF THE INVENTION

In one aspect, the present invention relates to an article of manufacture, which includes a fiber mat. In one embodiment, the fiber mat includes at least one type of fibers, where the at least one type of fibers includes one or more polymers.

In certain embodiments, the fiber mat is a single fiber mat including one type of fibers, where the one type of fibers includes the one or more polymers.

In one embodiment, the one type of fibers further includes a plurality of particles of a catalyst. In certain embodiments, the catalyst includes platinum (Pt) particles, Pt alloy particles, Pt on carbon particles, precious metal particles, precious metal on carbon particles, precious metal based alloys, precious metal based alloys on carbon particles, silver (Ag) particles, nickel (Ni) particles, Ag alloy particles, Ni alloy particles, iron (Fe) particles, Fe alloy particles, palladium (Pd) particles, Pd alloy particles, core-shell catalyst particles, non-platinum group metal (PGM) fuel cell catalysts, or a combination thereof.

In certain embodiments, at least one of the one or more polymers serves as a polymer binder. In one embodiment, the polymer binder includes at least one of Nafion and polyvinylidene fluoride (PVDF).

In certain embodiments, the fiber mat is used to form an electrode. In one embodiment, the electrode is an anode electrode or a cathode electrode.

In certain embodiments, the fiber mat is a dual or multi fiber mat including a plurality of types of fibers, where each of the plurality of types of fibers includes the one or more polymers.

In certain embodiments, each of the plurality of types of fibers includes a first polymer and a second polymer, and has a different ratio of the first polymer and the second polymer.

In certain embodiments, at least one of the plurality of types of fibers includes a polymer not in another of the plurality of types of fibers.

In certain embodiments, at least one of the plurality of types of fibers further includes a plurality of particles of a catalyst. In certain embodiments, the catalyst includes platinum

(Pt) particles, Pt alloy particles, Pt on carbon particles, precious metal particles, precious metal on carbon particles, precious metal based alloys, precious metal based alloys on carbon particles, silver (Ag) particles, nickel (Ni) particles, Ag alloy particles, Ni alloy particles, iron (Fe) particles, Fe alloy particles, palladium (Pd) particles, Pd alloy particles, core-shell catalyst particles, non-platinum group metal (PGM) fuel cell catalysts, or a combination thereof.

In one embodiment, in the at least one of the plurality of types of fibers comprising the plurality of particles of the catalyst, at least one of the one or more polymers serves as a polymer binder. In one embodiment, the polymer binder includes at least one of Nafion and polyvinylidene fluoride (PVDF).

In certain embodiments, the fiber mat is used to form an electrode. In one embodiment, the electrode is an anode electrode or a cathode electrode.

In certain embodiments, the fiber mat is used to form an ion exchange membrane. In one embodiment, the ion exchange membrane is a cation exchange membrane or an anion exchange membrane.

In certain embodiments, the fiber mat is usable in an electrochemical device. In one embodiment, the electrochemical device is a fuel cell membrane-electrode-assembly (MEA).

Another aspect of the present invention relates to an electrode, which includes a fiber mat. In certain embodiments, the fiber mat includes at least one type of fibers, where the at least one type of fibers includes one or more polymers, and a plurality of particles of a catalyst.

In certain embodiments, the electrode is an anode electrode or a cathode electrode.

In certain embodiments, the catalyst includes platinum (Pt) particles, Pt alloy particles, Pt on carbon particles, precious metal particles, precious metal on carbon particles, precious metal based alloys, precious metal based alloys on carbon particles, silver (Ag) particles, nickel (Ni) particles, Ag alloy particles, Ni alloy particles, iron (Fe) particles, Fe alloy particles, palladium (Pd) particles, Pd alloy particles, core-shell catalyst particles, non-platinum group metal (PGM) fuel cell catalysts, or a combination thereof.

In certain embodiments, at least one of the one or more polymers serves as a polymer binder. In one embodiment, the polymer binder includes at least one of Nafion and polyvinylidene fluoride (PVDF).

In certain embodiments, the fiber mat is a single fiber mat including one type of fibers, where the one type of fibers includes the one or more polymers and the plurality of particles of the catalyst.

In certain embodiments, the fiber mat is a dual or multi fiber mat including a plurality of types of fibers, where each of the plurality of types of fibers includes the one or more polymers, and at least one of the plurality of types fibers includes the plurality of particles of the catalyst.

In certain embodiments, in the at least one of the plurality of types of fibers including the plurality of particles of the catalyst, at least one of the one or more polymers serves as a polymer binder. In one embodiment, the polymer binder includes at least one of Nafion and polyvinylidene fluoride (PVDF).

In certain embodiments, each of the plurality of types of fibers includes a first polymer and a second polymer, and has a different ratio of the first polymer and the second polymer.

In certain embodiments, at least one of the plurality of types of fibers includes a polymer not in another of the plurality of types of fibers. A further aspect of the present invention relates to a membrane, which includes a fiber mat. In certain embodiments, the fiber mat includes at least one type of fibers, where the at least one type of fibers includes one or more polymers.

In certain embodiments, the membrane is an ion exchange membrane. In one embodiment, the ion exchange membrane is a cation exchange membrane or an anion exchange membrane.

In certain embodiments, the fiber mat is a single fiber mat including one type of fibers, where the one type of fibers includes the one or more polymers.

In certain embodiments, the fiber mat is a dual or multi fiber mat including a plurality of types of fibers, where each of the plurality of types of fibers includes the one or more polymers.

In certain embodiments, each of the plurality of types of fibers includes a first polymer and a second polymer, and has a different ratio of the first polymer and the second polymer.

In certain embodiments, at least one of the plurality of types of fibers includes a polymer not in another of the plurality of types of fibers.

In a further aspect of the present invention, a fuel cell MEA is provided. The fuel cell MEA includes: an anode electrode formed by a first fiber mat; a cathode electrode formed by a second fiber mat; and a membrane formed by a third fiber mat, and disposed between the anode electrode and the cathode electrode. In certain embodiments, each of the first fiber mat, the second fiber mat and the third fiber mat includes at least one type of fibers, where the at least one type of fibers includes one or more polymers; and each of the first fiber mat and the second fiber mat further includes a plurality of particles of a catalyst.

In certain embodiments, the membrane is an ion exchange membrane. In one embodiment, the ion exchange membrane is a cation exchange membrane or an anion exchange membrane.

In certain embodiments, at least one of the first fiber mat, the second fiber mat and the third fiber mat is a single fiber mat comprising one type of fibers.

In certain embodiments, at least one of the first fiber mat, the second fiber mat and the third fiber mat is a dual or multi fiber mat comprising a plurality of types of fibers.

In certain embodiments, each of the plurality of types of fibers includes a first polymer and a second polymer, and has a different ratio of the first polymer and the second polymer.

In certain embodiments, at least one of the plurality of types of fibers includes a polymer not in another of the plurality of types of fibers.

In certain embodiments, in each of the first fiber mat and the second fiber mat, one of the one or more polymers serves as a polymer binder. In one embodiment, the polymer binder includes at least one of Nafion and polyvinylidene fluoride (PVDF).

In a further aspect, the present invention relates to an electrochemical device having one or more fuel cell MEAs claimed above.

These and other aspects of the present invention will become apparent from the following description of the preferred embodiments taken in conjunction with the following drawings, although variations and modifications thereof may be affected without departing from the spirit and scope of the novel concepts of the disclosure.

### BRIEF DESCRIPTION OF THE DRAWINGS

The accompanying drawings illustrate one or more embodiments of the invention and, together with the written description, serve to explain the principles of the invention. Wherever possible, the same reference numbers are used throughout the drawings to refer to the same or like elements of an embodiment.

FIG. 1 schematically shows a membrane-electrode-assembly (MEA) formed according to one embodiment of the present invention.

FIG. 2 shows H₂-air fuel cell performance at about 80° C., 100% relative humidity for an entirely electrospun MEA (E-MEA) compared to a standard MEA (Nafion® 212 membrane with decal electrodes).

FIG. 3 schematically shows a syringe as a single needle spinneret according to one embodiment of the present invention.

FIG. 4A schematically shows a multiple needle spinneret according to one embodiment of the present invention.

FIG. 4B schematically shows a multiple needle spinneret in a different perspective view according to one embodiment of the present invention.

FIG. 5 schematically shows single orifice spinnerets according to certain embodiments of the present invention, where (a) shows a single orifice spinneret having a block shape, (b) shows a single orifice spinneret having a cylinder shape, and (c) shows a photo of a single orifice spinneret.

FIG. 6 schematically shows a multiple orifice spinneret according to one embodiment of the present invention, where a metal block contains numerous small channels through which the electrospinning solution (or heated polymer/particle melt) is pumped.

FIG. 7 schematically shows an electrospinning apparatus for creating a nanofiber mat electrode according to one embodiment of the present invention.

FIG. 8 schematically shows a start-stop cycling protocol according to one embodiment of the present invention.

FIG. 9 schematically shows a load cycling protocol to assess cathode Pt dissolution in an accelerated durability test according to one embodiment of the present invention.

FIG. 10 schematically shows polarization curves for 5 cm² MEAs with a Nafion 211 membrane and electrospun nanofiber electrodes with cathode and anode Pt loading of 0.10±0.005 mg/cm² according to one embodiment of the present invention, where (□) shows TKK TEC10E50E (Pt/HSAC), and () shows Johnson Matthey HiSpec® 4000 (Pt/Vulcan).

FIG. 11 schematically shows fuel cell polarization curves for 5 cm² MEAs with Tanaka Kikinzoku Kogyo (henceforth abbreviated as TKK) Pt/HSAC catalyst (where HSAC deontes high surface area carbon) and Nafion 211 (abbreviated as NR211) membrane operated at 80° C. with fully humidified H₂/air at ambient pressure according to one embodiment of the present invention, where the weight ratios of Pt/HSAC:Nafion:PAA are: () 72:13:15, (□) 63:22:15, and (A) 55:30:15 (where PAA is an abbreviation for poly(acrylic acid)).

FIG. 12 schematically shows fuel cell polarization curves for 5 cm² MEAs with TKK Pt/HSAC catalyst and NR211 membrane operated at 80° C. with fully humidified H₂/air at ambient pressure according to one embodiment of the present invention, where (□) shows electrospun fibers (with PAA), () shows painted gas diffusion electrode (abbreviated as GDE) (no PAA), and (Δ) shows painted GDE (with PAA).

FIG. 13 shows top-down 6,000× SEM images of an electrospun Pt/C/Nafion/PAA nanofiber mat with an average fiber diamter of (a) 250 nm and (b) 475 nm according to certain embodiments of the present invention.

FIG. 14A schematically shows the effect of electrode structure on MEA performance with Johnson Matthey (JM) Pt/Vulcan catalyst using nanofiber electrode MEA and traditonal spray-coated MEA at 100% RH according to certain embodiments of the present invention.

FIG. 14B schematically shows the effect of electrode structure on MEA performance with JM Pt/Vulcan catalyst using nanofiber electrode MEA and traditonal spray-coated electrode MEA at 40% relative humidity (RH) according to certain embodiments of the present invention.

FIG. 15A schematically shows the effect of electrode structure on MEA durability showing nanofiber electrospun and traditonal spray-coated MEAs using JM Pt/Vulcan catalyst at 100% RH according to certain embodiments of the present invention.

FIG. 15B schematically shows the effect of electrode structure on MEA durability showing nanofiber electrospun and traditonal spray-coated MEAs using JM Pt/Vulcan catalyst at 40% RH according to certain embodiments of the present invention.

FIG. 16 schematically shows real time measurement of ppm CO₂ at the cathode exhaust during start-stop potential cycling (100% RH condition) of nanofiber electrode and traditional spray-coated MEAs using JM Pt/Vulcan catalyst according to certain embodiments of the present invention.

FIG. 17 schematically shows carbon loss calculated from data as shown in FIG. 16 according to certain embodiments of the present invention. FIG. 18 schematically shows top-down 6,000× SEM image of an electrospun fiber mat with Pt/C catalyst particles with a binder of (a) Nafion+PVDF and (b) PVDF according to certain embodiments of the present invention.

FIG. 19 schematically shows power density curves for 5 cm² MEAs with a Nafion 211 membrane and cathode and anode Pt loading of 0.10 mg/cm² with Johnson Matthey HiSpec 4000 catalyst according to certain embodiments of the present invention.

FIG. 20 schematically shows power density and polarization curves for a 5 cm² MEA with a Nafion 211 membrane and a nanofiber cathode and anode according to certain embodiments of the present invention.

### DETAILED DESCRIPTION OF THE INVENTION

The invention will now be described more fully hereinafter with reference to the accompanying drawings, in which exemplary embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art. Like reference numerals refer to like elements throughout.

The terms used in this specification generally have their ordinary meanings in the art, within the context of the invention, and in the specific context where each term is used. Certain terms that are used to describe the invention are discussed below, or elsewhere in the specification, to provide additional guidance to the practitioner regarding the description of the invention. For convenience, certain terms may be highlighted, for example using italics and/or quotation marks. The use of highlighting has no influence on the scope and meaning of a term; the scope and meaning of a term are the same, in the same context, whether or not it is highlighted. It will be appreciated that the same thing can be said in more than one way. Consequently, alternative language and synonyms may be used for any one or more of the terms discussed herein, nor is any special significance to be placed upon whether or not a term is elaborated or discussed herein. Synonyms for certain terms are provided. A recital of one or more synonyms does not exclude the use of other synonyms. The use of examples anywhere in this specification including examples of any terms discussed herein is illustrative only, and in no way limits the scope and meaning of the invention or of any exemplified term. Likewise, the invention is not limited to various embodiments given in this specification.

It will be understood that when an element is referred to as being “on” another element, it can be directly on the other element or intervening elements may be present there between. In contrast, when an element is referred to as being “directly on” another element, there are no intervening elements present. As used herein, the term “and/or” includes any and all combinations of one or more of the associated listed items.

It will be understood that, although the terms first, second, third, etc. may be used herein to describe various elements, components, regions, layers and/or sections, these elements, components, regions, layers and/or sections should not be limited by these terms. These terms are only used to distinguish one element, component, region, layer or section from another element, component, region, layer or section. Thus, a first element, component, region, layer or section discussed below could be termed a second element, component, region, layer or section without departing from the teachings of the invention.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising”, or “includes” and/or “including” or “has” and/or “having” when used in this specification specify the presence of stated features, regions, integers, steps, operations, elements, and/or components, but do not preclude the presence or addition of one or more other features, regions, integers, steps, operations, elements, components, and/or groups thereof.

Furthermore, relative terms, such as “lower” or “bottom” and “upper” or “top”, may be used herein to describe one element's relationship to another element as illustrated in the Figures. It will be understood that relative terms are intended to encompass different orientations of the device in addition to the orientation depicted in the Figures. For example, if the device in one of the figures is turned over, elements described as being on the “lower” side of other elements would then be oriented on “upper” sides of the other elements. The exemplary term “lower” can, therefore, encompass both an orientation of “lower” and “upper”, depending on the particular orientation of the figure. Similarly, if the device in one of the figures is turned over, elements described as “below” or “beneath” other elements would then be oriented “above” the other elements. The exemplary terms “below” or “beneath” can, therefore, encompass both an orientation of above and below.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

As used herein, “around”, “about”, “substantially” or “approximately” shall generally mean within 20 percent, preferably within 10 percent, and more preferably within 5 percent of a given value or range. Numerical quantities given herein are approximate, meaning that the term “around”, “about”, “substantially” or “approximately” can be inferred if not expressly stated.

As used herein, the terms “comprise” or “comprising”, “include” or “including”, “carry” or “carrying”, “has/have” or “having”, “contain” or “containing”, “involve” or “involving” and the like are to be understood to be open-ended, i.e., to mean including but not limited to.

The terms “proton exchange membrane” or its abbreviation “PEM”, as used herein, refer to a membrane generally made from ionomers and designed to conduct protons. A PEM is a cation exchange membrane. The terms “proton exchange membrane fuel cell” or “PEM fuel cell”, or its abbreviation “PEMFC”, refer to a fuel cell using the PEM.

The terms “anion exchange membrane” or its abbreviation “AEM”, as used herein, refer to a membrane generally made from ionomers and designed to conduct anions. The terms “anion exchange membrane fuel cell” or “AEM fuel cell”, or its abbreviation “AEMFC”, refer to a fuel cell using the AEM.

As used herein, the term “conducting polymer” or “ionomer” generally refers to a polymer that conducts ions. More precisely, the ionomer refers to a polymer that includes repeat units of at least a fraction of ionized units. As used herein, the term “polyelectrolyte” generally refers to a type of ionomer, and particularly a polymer whose repeating units bear an electrolyte group, which will dissociate when the polymer is exposed to aqueous solutions (such as water), making the polymer charged. The conducting polymers, ionomers and polyelectrolytes may be generally referred to as “charged polymers”. As used herein, the terms “polyelectrolyte fiber” or “charged polymer fiber” generally refer to the polymer fiber formed by polyelectrolytes or the likes. As used herein, polyelectrolyte, ionomer, and charged polymer can be used interchangeably.

As used herein, the terms “uncharged polymer” or “uncharged (or minimally charged) polymer” generally refer to the polymer that does not effectively conduct ions, particularly to the polymer whose repeating units do not bear an electrolyte group or bear a small number of electrolyte groups, and thus the polymer will not be charged or will have a very small charge when being exposed to aqueous solutions. As used herein, the terms “uncharged polymer fiber” or “uncharged (or minimally charged) polymer fiber” generally refer to the polymer fiber formed by the uncharged/uncharged (or minimally charged) polymer.

As used herein, “nanoscopic-scale”, “nanoscopic”, “nanometer-scale”, “nanoscale”, “nanocomposites”, “nanoparticles”, the “nano-” prefix, and “nanostructure” generally refers to elements or articles having widths or diameters of less than about 1 μm. In all embodiments, specified widths can be smallest width (i.e. a width as specified where, at that location, the article can have a larger width in a different dimension), or largest width (i.e. where, at that location, the article's width is no wider than as specified, but can have a length that is greater). In describing nanostructures, the sizes of the nanostructures refer to the number of dimensions on the nanoscale. For example, nanotextured surfaces have one dimension on the nanoscale, i.e., only the thickness of the surface of an object is between 1.0 and 1000.0 nm. Nanowires have two dimensions on the nanoscale, i.e., the diameter of the tube is between 1.0 and 1000.0 nm; its length could be much greater. Finally, sphere-like nanoparticles have three dimensions on the nanoscale, i.e., the particle is between 1.0 and 1000.0 nm in each spatial dimension. A list of nanostructures includes, but not limited to, nanoparticle, nanocomposite, quantum dot, nanofilm, nanoshell, nanofiber, nanowire, nanotree, nanobrush, nanotube, nanorod, and so on.

The description is now made as to the embodiments of the invention in conjunction with the accompanying drawings. Although various exemplary embodiments of the present invention disclosed herein may be described in the context of fuel cells, it should be appreciated that aspects of the present invention disclosed herein are not limited to being used in connection with one particular type of fuel cell such as a proton exchange membrane (PEM) fuel cell and may be practiced in connection with other types of fuel cells or other types of electrochemical devices such as capacitors and/or batteries without departing from the scope of the present invention disclosed herein.

In accordance with the purposes of this invention, as embodied and broadly described herein, this invention relates to an integration/combination of nanofiber electrodes with a nanofiber-based membrane or nanofiber electrodes with a non-nanofiber based membrane to create a fuel cell membrane-electrode-assembly (MEA) for an electrochemical device, where each of the nanofiber electrodes and the nanofiber membrane is fabricated by an electrospinning process. Those skilled in the art will recognize that the electrospinning process typically involves applying a high voltage electric field to a spinneret needle containing a polymer solution or polymer melt. Charges on the surface of the solution as it emerges from the spinneret overcome the surface tension such as to produce and eject a thin liquid jet of the solution from the tip of the spinneret needle. As the jet of electrified solution travels towards a collector with a different electric potential, electrostatic repulsion from surface charges causes the diameter of the jet to narrow. The jet may enter a whipping mode and thereby be stretched and further narrowed due to instabilities in the electric field. Solid fibers are produced as the jet dries and the fibers accumulate on the collector to form a non-woven material.

One aspect of the present invention relates to a fiber mat. In one embodiment, the fiber mat includes at least one type of fibers, where the at least one type of fibers includes one or more polymers.

In certain embodiments, the fiber mat is a single fiber mat including one type of fibers, where the one type of fibers includes the one or more polymers.

In one embodiment, the one type of fibers further includes a plurality of particles of a catalyst. In certain embodiments, the catalyst includes platinum (Pt) particles, Pt alloy particles, Pt on carbon particles, precious metal particles, precious metal on carbon particles, precious metal based alloys, precious metal based alloys on carbon particles, silver (Ag) particles, nickel (Ni) particles, Ag alloy particles, Ni alloy particles, iron (Fe) particles, Fe alloy particles, palladium (Pd) particles, Pd alloy particles, core-shell catalyst particles, non-platinum group metal (PGM) fuel cell catalysts, or a combination thereof. In certain embodiments, at least one of the one or more polymers serves as a polymer binder. In one embodiment, the polymer binder includes at least one of Nafion and polyvinylidene fluoride (PVDF). In other words, the polymer binder may include Nafion only, PVDF only, or both Nafion and PVDF.

In certain embodiments, the fiber mat is a dual or multi fiber mat including a plurality of types of fibers, where each of the plurality of types of fibers includes the one or more polymers. In other words, two or more types of fibers are in the dual or multi fiber mat.

In certain embodiments, at least one of the plurality of types of fibers is configured to melt to fill in a space between the other of the plurality of types of fibers. In other words, one of the types of fibers may be melted to fill in the space between other fibers.

In certain embodiments, each of the plurality of types of fibers may include the same type of polymers having different ratios. For example, each of the plurality of types of fibers may include a first polymer and a second polymer, and has a different ratio of the first polymer and the second polymer.

In certain embodiments, each of the plurality of types of fibers may include at least one different type of polymers. For example, at least one of the plurality of types of fibers may include a polymer not in another of the plurality of types of fibers.

In certain embodiments, at least one of the plurality of types of fibers further includes a plurality of particles of a catalyst. In certain embodiments, the catalyst includes platinum (Pt) particles, Pt alloy particles, Pt on carbon particles, precious metal particles, precious metal on carbon particles, precious metal based alloys, precious metal based alloys on carbon particles, silver (Ag) particles, nickel (Ni) particles, Ag alloy particles, Ni alloy particles, iron (Fe) particles, Fe alloy particles, palladium (Pd) particles, Pd alloy particles, core-shell catalyst particles, non-platinum group metal (PGM) fuel cell catalysts, or a combination thereof.

In one embodiment, in the at least one of the plurality of types of fibers comprising the plurality of particles of the catalyst, at least one of the one or more polymers serves as a polymer binder. In one embodiment, the polymer binder includes at least one of Nafion and polyvinylidene fluoride (PVDF).

In certain embodiments, the fiber mat having the particles may be used to form an electrode. In one embodiment, the electrode is an anode electrode or a cathode electrode.

In certain embodiments, the fiber mat without the particles may be used to form an ion exchange membrane. In one embodiment, the ion exchange membrane is a cation exchange membrane or an anion exchange membrane.

In certain embodiments, the fiber mat is usable in an electrochemical device. In one embodiment, the electrochemical device is a fuel cell membrane-electrode-assembly (MEA).

In certain embodiments, the fuel cell MEA may include an anode electrode formed by a first fiber mat; a cathode electrode formed by a second fiber mat; and a membrane formed by a third fiber mat, and disposed between the anode electrode and the cathode electrode. Each of the first, second and third fiber mats may be the same or different fiber mats as described above.

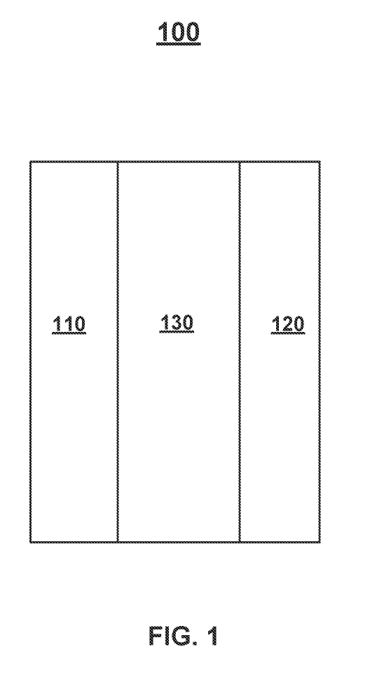

Referring to FIG. 1, an MEA 100 is shown according to one embodiment of the present invention. The MEA 100 in use may be incorporated into an electrochemical device, for example, a proton exchange membrane (PEM) fuel cell. The MEA 100 has an anode electrode 110, a cathode electrode 120, and a membrane 130, where the anode electrode 110 and the cathode electrode 120 are respectively attached to the opposing surfaces of the membrane 130. In the MEA, one or both electrodes 110 and/or 120 are formed of electrospun nanofibers, and the membrane 130 contains electrospun nanofibers. Embodiments of the nanofiber membrane and the nanofiber electrodes and their fabrications are respectively disclosed in co-pending U.S. patent application Ser. Nos. 13/567,857 and 13/823,968, which are incorporated herein in their entireties by reference. Please refer to the disclosures of co-pending U.S. patent application Ser. Nos. 13/567,857 and 13/823,968 for the details. In certain embodiments, the thickness of each of the anode electrode 110 and the cathode electrode 120 may be about 1-30 microns, and the thickness of the membrane 130 may be about 10-200 microns. The following description summarizes only the key features of the nanofiber membrane and the nanofiber electrodes and their fabrications.

The membrane 130 is ionically conductive, or proton conductive. In one embodiment, the membrane includes nanofibers of an uncharged (or minimally charged) polymer surrounded by a matrix of a proton conducting polymer. In another embodiment, the membrane includes nanofibers of a proton conducting polymer surrounded by a matrix of an uncharged (or minimally charged) polymer. In one embodiment, the uncharged (or minimally charged) polymer is polyphenylsulfone, and the proton conducting polymer is a perfluorosulfonic acid polymer. In one embodiment, the perfluorosulfonic acid polymer is Nafion®.

In certain embodiments, at least one of the anode electrode 110, the cathode electrode 120 and the membrane 130 may be formed of a fiber mat. In certain embodiments, the fiber mat may be a single fiber mat, a dual fiber mat, or a multi fiber mat. The single fiber mat is formed of a single polymer fiber, which is generated by performing fiber electrospinning on one polymer solution. The dual or multi fiber mat is formed of one or more first-type polymer fibers and one or more second-type polymer fibers. Specifically, the dual or multi fiber mat is formed by dual or multi fiber electrospinning, using two or more different polymer solutions to generate the two or more different types of polymer fibers. In certain embodiments, the polymer fiber used to form the membrane 130 may be different from either one of the polymer fibers used to form the anode electrode 110 and the cathode electrode 120.

In one embodiment, the anode electrode 110 and the cathode electrode 120 may be formed of a single fiber mat of one type of polymer fiber. In one embodiment, the polymer solution used to form the polymer fiber is formed by a solvent and a polymer solute distributed in the solvent. The polymer solute includes a plurality of particles of a catalyst, and a polymer binder distributed thereon. In this case, the polymer fiber includes the particles of the catalyst and the polymer binder, and may include a part of the solvent. In certain embodiments, the polymer binder used to form the anode electrode 110 and the cathode electrode 120 may include DuPont's Nafion® and polyvinylidene fluoride, which is henceforth abbreviated as PVDF.

In one embodiment, the membrane 130 includes a fiber network, formed from a dual or multi fiber mat of one or more first-type polymer fibers and one or more second-type polymer fibers; and a polymer matrix encompassing the fiber network, where the polymer matrix is formed by softening and flowing at least one of the one or more of the first-type polymer fibers of the dual or multi fiber mat to fill in the void space between the one or more second-type polymer fibers of the dual or multi fiber mat, or by softening and flowing at least one of the one or more of the second-type polymer fibers of the dual or multi fiber mat to fill in the void space between the one or more first-type polymer fibers of the dual or multi fiber mat. The one or more first-type polymer fibers include charged polymer fibers or charged polymer precursor fibers, and the one or more second-type polymer fibers include uncharged polymer fibers. In one embodiment, for each of the one or more first-type polymer fibers and each of the one or more second-type polymer fibers, the polymer solution used to form the polymer fiber is formed by a solvent and a polymer solute distributed in the solvent. The polymer solute includes a polymer, but does not include any particles. In this case, the polymer fiber formed includes the polymer, and may include a part of the solvent. It should be noted that the polymer used to form the first-type polymer fibers and the polymer used to form the second-type polymer fibers may be different. In certain embodiments, the polymer solute includes a polymer and particles of the catalyst.

In one embodiment, the one or more first-type polymer fibers include proton conducting polymer fibers, and the one or more second-type polymer fibers includes uncharged (or minimally charged) polymer fibers. In one embodiment, the uncharged (or minimally charged) polymer is polyphenylsulfone, and the proton conducting polymer is a perfluorosulfonic acid polymer.

In one embodiment, the membrane is fabricated by the following steps: At first, one or more first-type polymer solutions are formed from one or more first-type polymers and one or more second-type polymer solutions from one or more second-type polymers, respectively. Each of the one or more first-type polymers includes a charged polymer, while each of the one or more second-type polymers includes a uncharged (or minimally charged) polymer. Next, the one or more first-type polymer solutions and the one or more second-type polymer solutions are electrospun, separately and simultaneously, to form a dual or multi fiber mat of one or more first-type polymer fibers and one or more second-type polymer fibers. Then, the dual or multi fiber mat is processed by softening and flowing at least one of the one or more first-type polymer fibers to fill in the void space between the one or more second-types polymer fibers, or by softening and flowing at least one of the one or more second-type polymer fibers to fill in the void space between the one or more first-types polymer fibers, so as to form the membrane.

In one embodiment, the processing step includes the steps of compressing the dual or multi fiber mat; and thermal annealing the dual or multi fiber mat to soften and flow at least one of the one or more first-type polymer fibers to fill in the void space between the one or more second-type polymer fibers.

In another embodiment, the processing step includes the steps of compressing the dual or multi fiber mat; and exposing the dual or multi fiber mat to solvent vapor to soften and flow at least one of the one or more second-type polymer fibers to fill in the void space between the one or more first-type polymer fibers. In one embodiment, the processing step further includes the steps of thermal annealing the dual or multi fiber mat.

In one embodiment, each of the anode and cathode electrodes includes a catalyst. In one embodiment, the catalyst includes platinum-supported carbon (Pt/C).

In one embodiment, at least one of the anode electrode and the cathode electrode is formed of nanofibers by electrospinning of a polymer solution containing the catalyst and an ionomer or an uncharged (or minimally charged) polymer. In one embodiment, the ionomer polymer includes Nafion®. In another embodiment, the uncharged polymer includes PVDF.

In one embodiment, each of the anode electrode and the cathode electrode is fabricated by forming a polymer solution containing the catalyst and the ionomer or an uncharged (or minimally charged) polymer; electrospinning the polymer solution to generate electrospun fibers so as to form a nanofiber mat; and pressing the nanofiber mat to fabricate the electrode.

In one embodiment, the anode and cathode electrodes are separated by a PEM. The MEA is disposed between two flow-field plates, and in operation, hydrogen and air or some other fuel and oxidant are provided to the electrodes of the MEA via channels that are formed in the flow field plates. More particularly, one flow-field plate directs hydrogen to the anode and another flow-field plate directs oxygen in the air to the cathode. At the anode, a catalyst layer facilitates separation of the hydrogen into protons and electrons. Free electrons produced at the anode are conducted as a usable electric current through an external circuit. At the cathode, hydrogen protons that have passed through the PEM come together with oxygen in air and electrons that return from the external circuit, to form water and heat.

The fuel cell MEA may also have a first gas diffusion layer disposed between the anode electrode and the anode gas channel; and a second gas diffusion layer disposed between the cathode electrode and the cathode gas channel. In one embodiment, the first and second gas diffusion layers are formed of electrospun nanofibers.

In one embodiment, a first entirely electrospun fuel cell MEA has been fabricated (e.g., a fuel cell MEA containing an electrospun anode, an electrospun cathode and an electrospun membrane). The electrospun membrane has been shown to provide enhanced fuel cell durability relative to commercial Nafion® films, while the electrospun electrodes have been shown to provide enhanced fuel cell power output and durability, as compared to conventional/benchmark “decal” electrodes [4, 5]. Thus, the combination of these two materials into a single MEA has considerable advantages over current fuel cell MEA technologies (i.e., decal electrodes on a commercial Nafion® membrane or catalyst coated gas diffusion layers that are hot pressed onto a proton conducting membrane).

In the following example, the electrospun MEA (E-MEA) was constructed by separately preparing an electrospun membrane and electrospun electrodes (anode and cathode) and then hot-pressing the components into a single MEA construct. However, according to the invention, the fuel cell MEA can also be fabricated by forming a first electrospun nanofiber electrode; sequentially forming a electrospun nanofiber membrane on the first electrospun nanofiber electrode; and sequentially forming a second electrospun nanofiber electrode on the electrospun nanofiber membrane to construct the fuel cell MEA, where one of the first and second electrospun nanofiber electrodes is an anode electrode, and the other of the first and second electrospun nanofiber electrodes is a cathode electrode. Additionally,

Without intent to limit the scope of the invention, descriptions and processing for the membrane and electrodes are described as follows. In the exemplary embodiment, the membrane is formed such that a proton conducting polymer is reinforced by an electrospun nanofiber mat of an uncharged polymer. Variants of this construct, for example, a membrane is formed such that the uncharged polymer surrounds an electrospun mat of proton conducting nanofibers, or one electrode (e.g., the anode) contains no nanofiber in structure, can also be utilized to the practice the invention.

### EXAMPLE ONE

### Preparation of Nanofiber Membrane

Separate Nafion® and polyethylene oxide (PEO) solutions were prepared by dissolving Nafion® powder (prepared by evaporating the solvent from LIQUION 1115, Ion Power, Inc.) and PEO powder (Sigma-Aldrich, 400 kDa MW) into a 2:1 weight ratio n-propanol:water mixture. These two solutions were then combined to form a Nafion®/PEO electrospinning solution where the PEO constituted about 1 wt % of the total polymer content.

A polyphenylsulfone (Radel® R 5500NT, 63 kDa MW, from Solvay Advanced Polymers, LLC) solution was prepared by dissolving polymer powder in an 80:20 wt. ratio of n-methyl-2-pyrrolidone:acetone. The polyphenylsulfone (PPSU) solution and the Nafion®/PEO solution were each drawn into separate syringes and electrospun using a 22 gauge needle (Hamilton Company). PPSU fibers and Nafion®/PEO fibers were simultaneously collected on a rotating aluminum drum that also oscillated laterally to ensure a random distribution and orientation of fibers with a uniform fiber density. The flow rates and concentrations of the Nafion®/PEO and the PPSU were varied to produce fiber mats of varying compositions (i.e., different Nafion® volume fractions). The Nafion®/PEO solution was electrospun at a flow rate of about 0.20 mL/hr and a concentration of about 20 wt %. The PPSU solution was electrospun at a flow rate of about 0.038 mL/hr, at a constant concentration of about 25 wt %. For the Nafion®/PEO electrospinning, a spinneret-to-collector distance (SCD) was fixed at about 6.5 cm and the voltage was set at about 4.15 kV. The PPSU solution was electrospun at about 8.5 kV with an SCD of about 8.5 cm. All electrospinning experiments were performed at room temperature, where the relative humidity was about 35%.

The electrospun dual nanofiber mat was compressed at about 15,000 psi and about 127° C. for about 10 seconds. The sample was rotated 90° three times and successively compressed to ensure even compression. The dual nanofiber mat was then annealed in vacuum at about 150° C. for about 2 hours so as to produce the membrane. The resulting membrane, where PPSU nanofibers are embedded in a Nafion® polymer matrix, was boiled in about 1 M sulfuric acid and deionized water for about one hour each to remove residual PEO and to protonate all ion-exchange sites.

### Preparation of Nanofiber Electrode:

An electrospinning cathode dispersion (ink) was prepared by mixing Pt/C particles (about 40% Pt on carbon black, from Alfa Aesar), Nafion® powders (made by drying a LIQUION 1115 solution from Ion Power, Inc.) and poly(acrylic acid) (MW =450,000 g/mol, from Aldrich) in a 2:1 wt ratio isopropanol:water solvent. The total polymer plus powder content of the ink was about 13.4 wt %, where the Pt/C:Nafion®:PAA weight ratio was about 72:13:15.

The ink was pumped out of a needle spinneret (a 22 gauge needle) and deformed into a Taylor cone by the strong applied potential at the needle tip, +7.0 kV relative to a grounded stainless steel rotating drum nanofiber collector. The spinneret-to-collector distance was fixed at about 9 cm, and the flow rate of ink was about 1.5 mL-h⁻¹. Nanofibers were collected on an aluminum foil that was fixed to the collector drum (rotating at about 100 rpm). The drum oscillated horizontally to improve the uniformity of deposited nanofibers. Prior to hot-pressing, the electrospun nanofiber mat was pre-compressed between two PTFE sheets under mild pressure (about 217 Pa). The Pt-loading of the nanofiber mat was calculated from its total weight and the weight-fraction of Pt/C catalyst used for its preparation.

### MEA Performance in a Fuel Cell

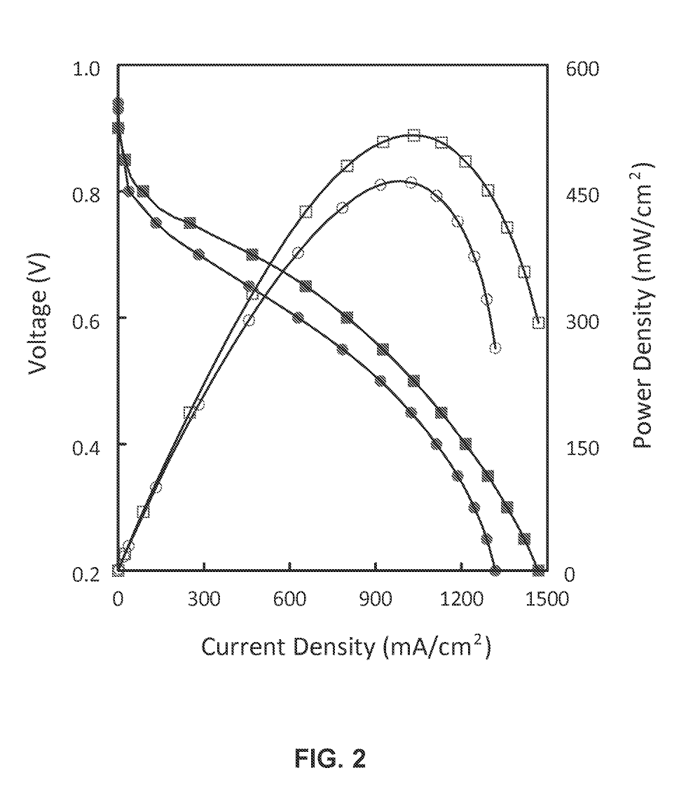

In this exemplary embodiment, the anode and cathode electrodes and the membrane were prepared separately. However, it should be appreciated that E-MEAs could also be fabricated by successively (sequentially) electrospinning nanofibers for the anode, the membrane, and the cathode and then processing the entire E-MEA simultaneously. In the exemplary embodiment, the membrane and electrodes were prepared separately, and the electrospun electrodes were hot-pressed onto the electrospun membrane at about 283° F. and about 100 psi for about 10 minutes. The E-MEA was then loaded into a fuel cell test fixture and pre-conditioned for about 3 hours at about 80° C. by successively running the fuel cell for about 2 minutes at low current density (about 150 mA/cm²) and about 2 minutes at low voltage (about 0.2V). Fuel cell performance at about 80° C. and about 100% relative humidity was then measured with a Scribner Fuel Cell Test Station. For comparison, similar MEA preparation/conditioning steps were performed using a commercial Nafion® membrane and decal electrodes. The Nafion®/decal MEA had the same loading of Pt catalyst in the electrodes (about 0.15 mg/cm² each for the anode and cathode) and the electrospun MEA. The fuel cell performance for both MEAs is shown in FIG. 2. As shown in FIG. 2, (▪) indicates E-MEA voltage vs. current density, (□) indicates E-MEA power density vs. current density, () indicates Nafion/decal voltage vs. current density, and (∘) indicates Nafion®/decal power density vs. current density. The H₂ flow rate was about 125 mL/min and the air flow rate was about 500 mL/min. The E-MEA was composed of an about 30 μm thick Nafion®/polyphenylsulfone electrospun membrane in which Nafion was reinforced by polyphenylsulfone nanofibers and the Nafion® content was about 65 vol %. The E-MEA anode and cathode were electrospun nanofiber mats having about 72 wt % Pt/C, about 13 wt % Nafion®, about 15 wt % PAA. Each electrode had a Pt loading of about 0.15 mg/cm². The Nafion®/decal MEA was a Nafion® 212 membrane (51 μm thick) with decal electrodes (about 0.15 mg/cm² Pt loading and was about 77 wt % Pt/C and about 23 wt % Nafion® binder). As can be seen, the E-MEA produced more power than the standard Nafion®/decal MEA at all operating voltages (the measured current density was higher at all cell voltages). At a typical fuel cell operating voltage of about 0.6V, the E-MEA has a power output of about 480 mW/cm², as compared to about 377 mW/cm² for a Nafion®/decal MEA, which is a 27% improvement. The maximum power for the E-MEA is about 516 mW/cm², as compared to about 460 mW/cm² for the Nafion®/decal MEA.

In sum, the present invention, among other things, recites an entirely electrospun fuel cell MEA containing an electrospun anode, an electrospun cathode and an electrospun membrane, for the first time, which has considerable advantages over a conventional Nafion®/decal MEA.

### Needle and Needless Electrospinning of Nanofiber Electrodes

Nanofiber electrode mats can be created using equipment with different types of spinneret equipments. Some spinnerets can be termed “needle” spinnerets, whereas other equipment employs orifice (needleless) spinnerets or electrospinning equipment that does not rely on the use of a spinneret.

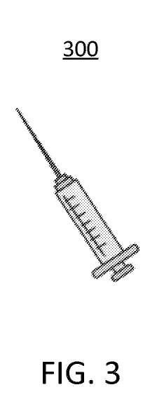

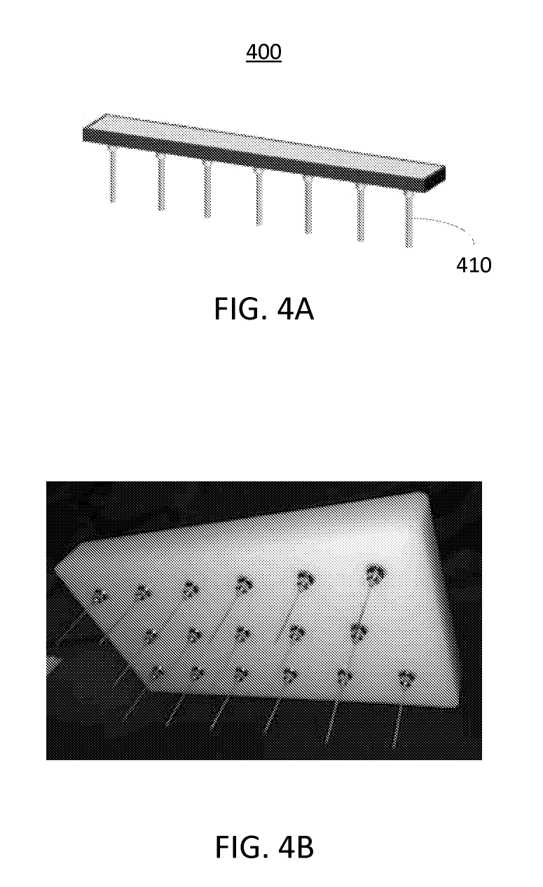

In certain embodiments, the generated particle/binder electrodes or nanofiber membrane may be generated using: (1) a single needle spinneret, or (2) a multiple needle spinneret. In certain embodiments, the single needle spinneret, in its simplest manifestation, is just a hypodermic needle syringe filled with the electrospinning solutions, which was used in the examples listed in the present disclosure. The configuration of the single needle spinneret may be a syringe. FIG. 3 schematically shows a syringe as a single needle spinneret according to one embodiment of the present invention. Specifically, FIG. 3 shows a cartoon sketch of such a syringe 300. FIGS. 4A and 4B show multiple needle spinnerets, in different perspective views, according to certain embodiments of the present invention. As shown in FIG. 4A, the multiple needle spinneret 400 has a plurality of needles.

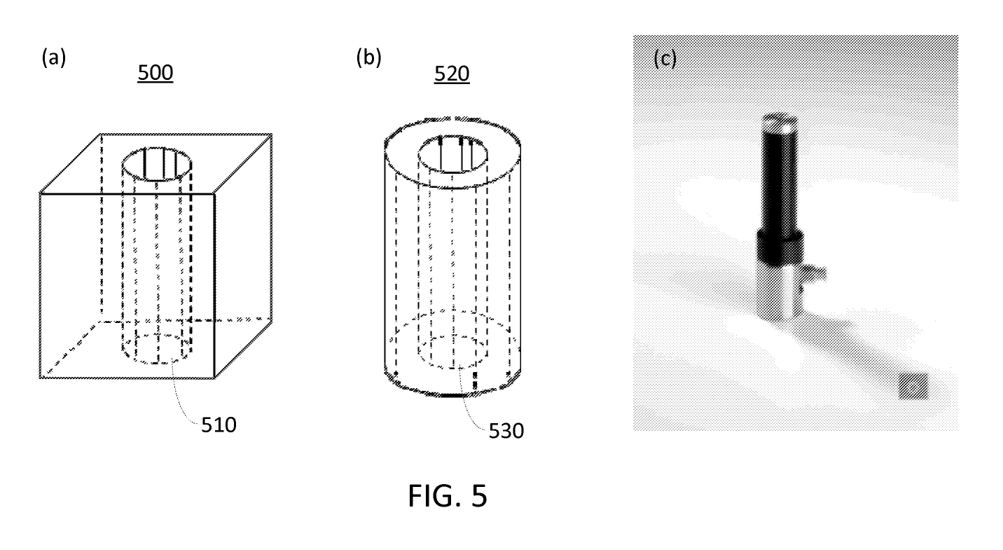

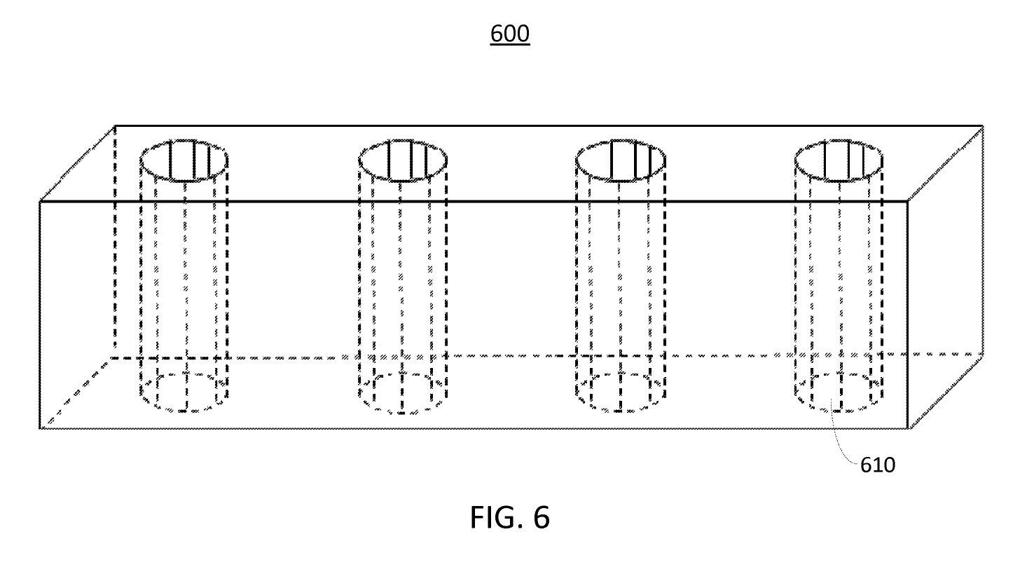

In certain embodiments, the generated particle/binder electrodes or nanofiber membrane may be generated using: (3) a single orifice spinneret, or (4) a multiple orifice spinneret. In certain embodiments, the single orifice spinneret or the multiple orifice spinneret may include the structure where a polymer solution or melt is forced through a small channel or multiple channels in a metal block, which is polarized at a high potential to create an electrospun fiber. FIG. 5 schematically shows single orifice spinnerets according to certain embodiments of the present invention. As shown in FIG. 5, (a) shows a single orifice spinneret 500 having a block shape, with the channel 510 passing through the block shape; and (b) shows a single orifice spinneret 520 having a cylinder shape, with the channel 530 passing through the cylinder shape. FIG. 5(c) shows a photo of a single orifice spinneret. FIG. 6 schematically shows a multiple orifice spinneret according to one embodiment of the present invention. As shown in FIG. 6, the multiple orifice spinneret 600 may include a structure where a metal block contains numerous small channels 610 through which the electrospinning solution (or heated polymer/particle melt) is pumped, as shown schematically in FIG. 6.

Additionally, it is possible to prepare nanofiber electrodes using electrospinning equipment that does not utilize a needle or orifice spinneret. In certain embodiments, for example, the electrospinning may be performed using the commercially available needle-free electrospinning Nanospider™ Technology patented by Elmarco Inc. Specifically, a polarized electrode is partially submerged or coated in a polymer solution, where one or many fiber filaments emerging from the free liquid surface [6].

In certain embodiments, the nanofibers may be created without the application of an electric field. For example, a new process called Forcespinning™[7] has been developed to make nanofibers from a wide range of materials. This new method uses centrifugal force, rather than and electric field, as occurs in a typical electrospinning process.

### Solutions for Electrospinning Nanofiber Electrodes

In certain embodiments, a variety of different solutions can be used to prepare nanofiber electrodes. Each solution contains a solvent, catalyst electrode particles, and a suitable binder. In some cases the binder is a proton conducting ionomer, such as a perfluorosulfonic acid polymer (e.g., DuPont's Nafion® or Solvay's Aquivion®) or a sulfonated hydrocarbon polymer. When DuPont's Nafion or some other perfluorosulfonic acid polymer is used as the binder, it is normally co-spun with a carrier polymer, such as poly(acrylic acid), abbreviated as PAA. In other cases, the binder is an uncharged polymer, such as PVDF. Nafion may also be mixed with PVDF and this mixture used as a catalyst binder for nanofiber electrodes. One skilled in the art should also recognize that, in principle, one could electrospin catalyst binder nanofibers from a high temperature polymer melt without the use of a solvent by heating suitably chosen polymer/catalyst mixtures.

To carry out the electrospinning process, the catalyst particles (powder) and polymer binder are mixed with a suitable solvent such an alcohol/water mixture or an acetone/water mixture, where the alcohol is, for example, methanol, ethanol, isopropanol, n-propanol or a mixture of alcohols. In certain embodiments, the total polymer and catalyst powder content of the electrospinning suspensions is typically between about 10-18 wt %, with the remaining wt % portion being solvent. In certain embodiments, the catalyst can be any electrically conducting electrode powder material, including Pt on carbon powder, a metal black powder such at Pt-black or Pd-black, a carbon-based non precious metal fuel cell catalyst, metal alloy and core-shell catalyst powders, or a precious metal on a non-carbon support. Table 1 lists examples of the range of composition of electrospun fiber electrodes, after solvent evaporation, in terms of the wt % of catalyst and polymer binder. Compositions are listed in terms of weight percentages of the final dry nanofiber mats. For the examples in Table 1, the Pt/C catalyst was Pt on carbon from either Johnson Matthey Company or Tanaka Kikinzoku Kogyo.

TABLE 1
Pt/C-Nafion-PAA and Pt/C-PVDF electrospun nanofiber
mat compositions after solvent evaporation.

| Pt/C | | | Polyvinylidene |
|---|---|---|---|
| Catalyst | Nafion | Poly(acrylic acid) | fluoride |
| wt % | wt % | (PAA) | (PVDF) |
| 55 | 30 | 15 | — |
| 63 | 22 | 15 | — |
| 65 | 23 | 12 | — |
| 72 | 13 | 15 | — |
| 75 | 15 | 10 | — |
| 75 | — | — | 25 |

### EXAMPLE TWO

In this example, a series of electrospun nanofiber mat electrodes with two different commercial Pt/C catalysts and 1100 EW Nafion® and poly(acrylic acid) binder were fabricated and evaluated. The electrodes were formed into membrane-electrode-assemblies (MEAs) using Nafion 211 as the membrane. The effects of catalyst type, nanofiber composition (the ratio of Pt/C to Nafion), and fiber diameter on hydrogen/air fuel cell power output were investigated using 5 cm² MEAs. In general, these variations in the anode and cathode had little or no impact on fuel cell performance. Cathode durability studies were performed, where nanofiber and conventional sprayed gas diffusion electrode MEAs were compared. MEA durability was evaluated under an automotive-specific start-stop cycling (carbon corrosion) protocol. The beginning of life (BoL) and end of life (EoL) performance of the nanofiber electrodes after durability cycling were compared with conventional spray-coated electrodes.

### Electrospinning Electrodes

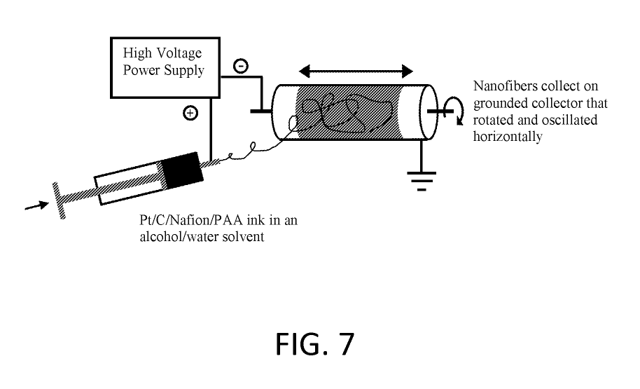

Electrospinning inks were prepared by mixing the following components in an alcohol/water solvent: (a) a commercial Pt/C catalyst powder, either Johnson Matthey (J M) HiSpec™ 4000 (40% Pt on Vulcan carbon), henceforth referred to as JM Pt(Vulcan), or Tanaka Kikinzoku Kogyo TEC10E50E (46.1% Pt on high surface area Ketjen Black carbon), henceforth referred to TKK Pt(HSAC), (b) Nafion® ion exchange resin (20% ionomer in alcohol/water from Aldrich), and (c) poly(acrylic acid) (MW=450 kDa from Aldrich). Nafion forms micelles in alcohol/water mixture and will not electrospin into well-formed fibers, unless a suitable carrier polymer is added to the electrospinning solution [8]. In the present study, poly acrylic acid (PAA) was used as the carrier. A suspension of Nafion and catalyst was first sonicated for 90 minutes with intermittent mechanical stirring before the addition of poly(acrylic acid). The entire mixture was then mechanically stirred for approximately 48 hours. The total polymer and powder content of the spinning suspensions was between 10-18 wt. %, and the Pt/C:Nafion:PAA weight ratio was varied so that the dry mat contained 55-72 wt. % Pt/C and 13-30 wt. % Nafion, where the PAA content was held constant at 15 wt. %. The inks were drawn into a 3 mL syringe and electrospun using a 22-gauge stainless steel needle spinneret, where the needle tip was polarized to a potential of 8-12 kV relative to a grounded stainless steel rotating drum collector that was operated at a rotation speed of 100 rpm. The spinneret-to-collector distance was fixed at 10 cm and the flow rate of ink was held constant for all experiments at 1.0 mL/h. Nanofibers were collected on an aluminum foil that was attached to the cylindrical collector drum. The drum oscillated horizontally to improve the uniformity of deposited nanofibers. FIG. 7 schematically shows an electrospinning apparatus for creating a nanofiber mat electrode according to one embodiment of the present invention. In certain embodiments, electrospinning was performed at room temperature in a custom-built environmental chamber, where the relative humidity was maintained constant at 40%.

### Membrane-Electrode-Assembly (MEA) Preparation

MEAs with nanofiber electrodes were fabricated at Vanderbilt University by hot pressing 5 or 25 cm² electrospun electrodes (anodes and cathodes of identical fiber composition) onto opposing sides of a Nafion 211 membrane (NR211) at 140° C. and 4 MPa for 1 minute, after a 10-minute heating period at 140° C. and 0 MPa. The Pt loading of a nanofiber mat was calculated from its total electrode weight and the weight-fraction of Pt/C catalyst used in the electrospinning ink. A carbon paper gas diffusion layer (GDL) (Sigracet 25 BCH GDL) was physically pressed onto the MEA's anode and cathode in the test fixture.

Painted gas diffusion electrodes (GDEs) were also fabricated at Vanderbilt University with and without PAA. Pt/C powder was mixed with a commercial Nafion dispersion in alcohol/water. PAA was added to some inks. The inks were painted in multiple layers directly onto the carbon gas diffusion paper (Sigracet GDL 25 BCH) and dried at 70° C. for 30 min after each painted layer. Painted GDEs with PAA were prepared with a composition of 72 wt. % TKK Pt/HSAC, 13 wt. % Nafion, and 15 wt. % PAA (the same as some electrospun fibers tested). GDEs without PAA were prepared with a composition of 67 wt.% Pt/HSAC and 33 wt. % Nafion. These 5 cm² GDEs were hot pressed onto NR211 membranes with fuel cell test fixture gaskets at the same conditions as those employed for the electrospun electrodes.

Traditional sprayed gas diffusion electrodes (GDEs) were fabricated at Nissan Technical Center North America (NTCNA) by spraying commercial Pt/C catalyst on SGL 25 BCH GDL using an automated robotic spray system. MEAs were prepared by hot pressing traditional Pt/C gas diffusion electrode (GDE) anodes, catalyst-coated experimental GDE cathodes, and NR211 membranes.

### Fuel Cell Test

Fuel cell polarization curves were collected at Vanderbilt University and Nissan Technical Center North America. At Vanderbilt University, fuel cell polarization curves were performed on 5 cm² MEAs. These data were collected using a Scribner Series 850e test station with mass flow, temperature, and manual backpressure control. The fuel cell test fixture accommodated a single MEA and contained single anode and cathode serpentine flow channels. Experiments in H₂/air were performed at 80° C. with fully humidified gases at atmospheric (ambient) pressure, with a H₂ flow rate of 125 sccm and an airflow rate of 500 sccm. Prior to collecting polarization data, the MEAs were pre-conditioned by operating at 80° C. and 1 A/cm² for 8 hours after shorter periods of lower current densities. Polarization curves were generated by measuring the current at a given voltage after waiting 60 seconds for system stabilization. The polarization curves were measured in the anodic (positive) direction.

At NTCNA, fuel cell polarization curves were obtained with 25 cm² MEAs at 100% and 40% relative humidities (RH) at 80° C., using hydrogen and air at 1.0 bar_{g}. The current was scanned from low current to high current and the system was given 3 minutes to stabilize at each current density before a voltage reading was recorded. MEAs were pre-conditioned by operating at 1.0 A/cm² at 80° C. for 8 hrs. In certain embodiments, HFR data were recorded in-situ at 1000 Hz. Performance evaluations were done using protocols designed to produce meaningful data for automotive applications. Constant gas flow rates used for these evaluations were high, 8.0 normal liters per minute (NLPM) at the cathode and 4.0 NLPM at the anode, with no/minimal pressure drop across the flow field. In certain embodiments, cathode catalyst mass activity data were collected with a current-controlled anodic scan (high current to low current) at 80° C. with fully humidified O₂ and H₂ gas feeds at 1.0 bar_{g}, where the system was allowed to stabilize for three minutes at each data point. Mass activities were determined from a plot of IR-free voltage verse the H₂-crossover corrected current density.

### Electrochemical Surface Area (ECA)

In-situ cyclic voltammetry (CV) measurements were performed at NTCNA on 25 cm² MEAs with a sweep rate 20 mV/s, where a H₂-purged anode served as both the counter and reference electrodes and N₂ was fed to the working cathode. The fuel cell test fixture was operated at 30° C. with gas feed streams at a dew point of 30° C. (fully humidified). The CV was carried out between +0.02 V and +0.9 V vs. SHE and the electrochemically active surface area was determined from the integrated area above the hydrogen adsorption portion of a voltammogram (corresponding to a voltage range of ca. +0.1 to +0.4 V), assuming a charge of 210 μC/cm² to reduce one monolayer of hydrogen atoms on Pt.

### Durability Test

MEAs were tested under the Fuel Cell Commercialization Conference of Japan's (FCCJ) standard start-stop potential cycling, and load cycling protocols. The goal of these accelerated degradation testing was to generate data for benchmarking and to gain a better understanding of the fundamental mechanisms related to cathode performance loss during fuel cell operation.

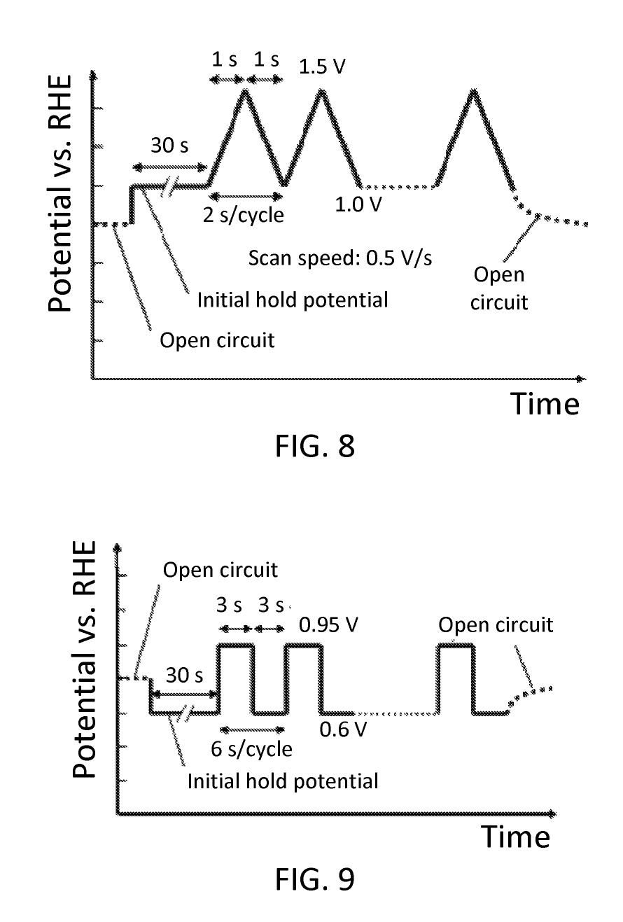

Carbon Corrosion (Start-stop cycling): FIG. 8 schematically shows a start-stop cycling protocol according to one embodiment of the present invention. As shown in FIG. 8, this accelerated durability test simulates start-up and shut-down of a stack without the application of any operational controls that may mitigate fuel cell performance losses. During start-up, if the stack has been shut down for some time, the anode and cathode are filled with ambient air and pinned to the air-air potential; introducing hydrogen gas causes a hydrogen-air front to move through the anode chamber, with a large shift in the cell potential (as high as 1.5 V). The start-stop durability protocol simulates this event many times by cycling from 1.0V to about 1.5 V at a scan rate of 500 mV/s. During this excursion, the carbon catalyst support in the cathode corrodes, degrading the operational performance of the fuel cell. The protocol used in the present study essentially evaluates the corrosion of the cathode catalyst support and the corresponding loss in area of Pt. ECA measurements were conducted intermittently after a certain number of cycles up to 1000 cycles. In addition, the fuel cell performance of MEAs were evaluated at the beginning of life (BoL) and end of life (EoL) to understand the effect of carbon support corrosion on iV polarization curves.

Real time measurement of CO₂ formation during carbon corrosion: Typically, carbon support durability is evaluated during a corrosion test by monitoring changes in electrochemical active area (ECA), double layer capacitance (C_{d1}), and i-V fuel cell performance. In the present study, CO₂ monitoring of the cathode air exhaust was added as an additional experimental tool for measuring and better understanding carbon corrosion during the accelerated potential cycling tests. During a start-stop cycling test, the fuel cell was supplied with H₂ at the anode and N₂ at cathode (both at 0.5 L/min, 80° C., fully humidified), and the cell potential was cycled using a potentiostat. The CO₂ in the cathode exhaust was measured using a non-dispersive infrared (NDIR) CO₂ detector obtained from CO₂ Meter Inc. (Model No. CM-0052-WP). A desiccant moisture trap just before the detector inlet removed moisture from the CO₂-containing stream. A detailed description of this system can be found in reference [9].

Load cycling: This accelerated durability potential cycling test simulates the high load and no load events that typically occur when a fuel cell vehicle is driven at different speeds. . The MEA was cycled in steps between 0.60 V and 0.95 V to simulate peak load and OCV/idle. The temperature, gas flow rate, and humidity operating conditions were the same as in the carbon corrosion test. Up to 10,000 voltage cycles were performed in a typical test. The voltage variations represent the largest oscillations that may be encountered during normal operation of a fuel cell vehicle stack. When the cell is cycled between 0.6 V and 0.95 V, carbon corrosion is insignificant and the major causes for power loss are Pt dissolution, agglomeration, and migration on the support and through the membrane. In the present study, Pt degradation was monitored by periodic measurement of the cathode Pt ECA and by comparing BoL and at the EoL i-V hydrogen/air fuel cell polarization curves.

Normally, the drop in iV performance under load cycling is not as severe as the start-stop accelerated durability test. The ECA loss under load cycling is highly dependent on the initial Pt particle size: the larger the Pt particles, the lower the ECA loss. It has been shown, however, that ECA loss does not necessarily translate to a significant iV performance drop. Consequently, the durability evaluations discussed herein for nanofiber electrodes were focused more on start-stop durability than load cycling durability.

### Results and Discussions

Testing of 5 cm² active area MEAs was carried out at Vanderbilt University. The purpose of these experiments was to understand better the effect of catalyst type, nanofiber composition and nanofiber diameter on fuel cell power output. Based on these results, the appropriate fiber diameter and ink composition were selected for the fabrication of 25 cm² nanofiber MEAs Nissan's for evaluation of performance and durability.

Effect of Catalyst Type: Johnson Matthey Pt/Vulcan and TKK Pt/HSAC catalysts were evaluated in nanofiber anode/cathode MEAs, where each electrode had a Pt loading of 0.10 mg/cm² and the Pt/C:Nafion:PAA wt. ratio composition of the fibers was 63:22:15.

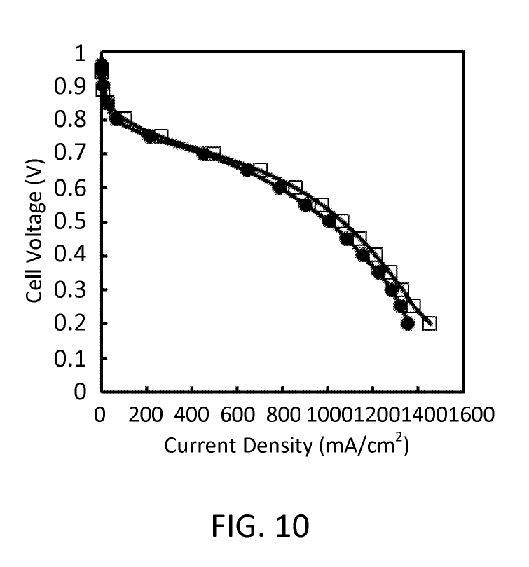

FIG. 10 schematically shows polarization curves for 5 cm² MEAs with a Nafion 211 membrane and electrospun nanofiber electrodes with cathode and anode Pt loading of 0.10±0.005 mg/cm² according to one embodiment of the present invention, where (□) shows TKK TEC10E50E (Pt/HSAC), and () shows Johnson Matthey HiSpec™ 4000 (Pt/Vulcan). Fuel cell operating conditions include: 80° C., 100% RH feed gases at ambient pressure, 125 sccm H₂ and 500 sccm air. As shown in FIG. 10, the polarization curves for the two catalysts were essentially the same. The TKK Pt/HSAC showed a modest advantage in current densities, but the difference was 10% at most, so there is no clear superiority of one catalyst material over the other.

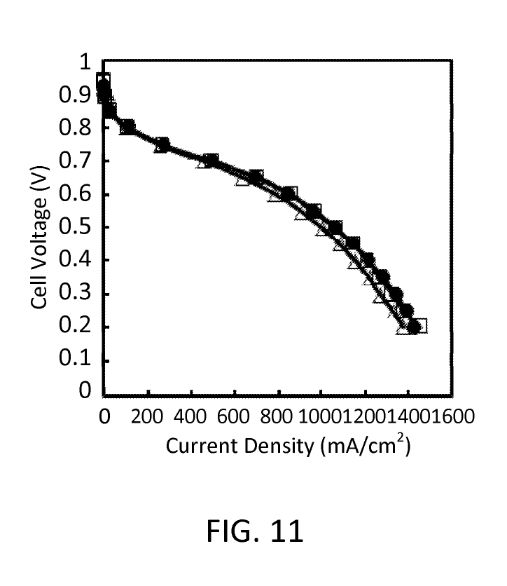

Effect of Nanofiber Composition (Catalyst to Ionomer Ratio): The relative amounts of catalyst to proton-conducting Nafion ionomer in electrospun nanofiber mats was varied, while the PAA carrier polymer was maintained constant at 15 wt. % and the cathode and anode Pt loadings were fixed at 0.10 mg/cm² each. FIG. 11 schematically shows fuel cell polarization curves for 5 cm² MEAs with TKK Pt/HSAC catalyst and NR211 membrane operated at 80° C. with fully humidified H₂/air at ambient pressure according to one embodiment of the present invention, where the weight ratios of Pt/HSAC:Nafion:PAA are: () 72:13:15, (□) 63:22:15, and (Δ) 55:30:15. The cathodes and anodes used to obtain the polarization curves as shown in FIG. 11 are electrospun and have a Pt loading of 0.10±0.005 mg/cm². The fuel cell polarization curves only show marginal differences for the three different MEAs. Unlike a conventional non-structured electrode morphology, where binder content has a significant effect on the porosity and performance of the electrode [10], the nanofiber cathode power output was unaffected by changes in Nafion content.

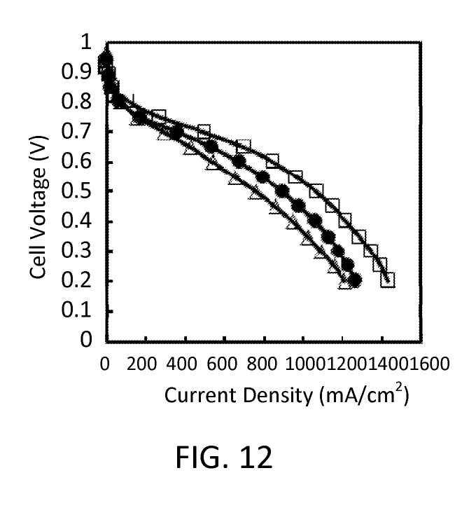

Effect of FAA: In order to quantify the influence of PAA polymer on cathode performance, two MEAs were prepared: one MEA had anode and cathode GDEs with a neat Nafion binder (67 wt. % Pt/HSAC, 33% Nafion) while the other MEA had GDEs with the same Nafion/PAA binder as a typical nanofiber electrode mat (72 wt. % Pt/HSAC, 13 wt. % Nafion , 15 wt. % PAA). FIG. 12 schematically shows fuel cell polarization curves for 5 cm² MEAs with TKK Pt/HSAC catalyst and NR211 membrane operated at 80° C. with fully humidified H₂/air at ambient pressure according to one embodiment of the present invention, where (□) shows electrospun fibers (with PAA), () shows painted GDE (no PAA), and (Δ) shows painted GDE (with PAA). The cathodes and anodes used to obtain the polarization curves as shown in FIG. 12 have a Pt loading of 0.10±0.005 mg/cm². As shown in FIG. 12, the MEA with PAA produced significantly less power than the PAA-free MEA. In a previous study on electrospinning Nafion nanofibers, it was found that the presence of PAA lowered the proton conductivity of Nafion. When PAA was removed from the painted anode GDE, the MEA continued to perform poorly. Therefore, the low power output in FIG. 12 has been tentatively associated with a low binder conductivity that primarily affects the cathode performance. Two different methods were investigated to remove PAA from nanofiber mat after electrospinning: (1) boiling a catalyst coated membrane for one hour in 1 M H₂SO₄ and one hour in boiling DI water and (2) soaking a catalyst coated membrane in 3% H₂O₂ for one hour at room temperature and then boiling for one hour in DI water. This result suggests that if PAA can be removed from cathode fibers, then the fuel cell performance may be boosted even higher.

Effect of Nanofiber Diameter: Two methods were found to be most effective in controlling (decreasing) fiber diameter during electrospinning: (i) decreasing the wt. % Pt/C powder and total polymer (Nafion +PAA) in the ink from 18wt.% to 10 wt.% and (ii) the use of alcohol solvents of higher boiling points in the electrospinning ink. For a spinning solution with a Pt/C+Nafion+PAA content less than 10 wt. %, well-formed fibers could not be made (with ink electrosprayed into droplets). As shown in Table I, the diameter of electrospun nanofibers was effectively varied from 250 to 520 nm. The solvent type and % alcohol in the ink are also listed in the table. For each of these fiber mats, the Pt/C-Nafion-PAA composition was fixed at 63 wt. % Pt/C, 22 wt. % Nafion, and15 wt. % PAA. TKK Pt/HSAC catalyst powder was used in all of the inks. The solvents used, in order of decreasing fiber diameter, were methanol, ethanol, isopropanol, and n-propanol.

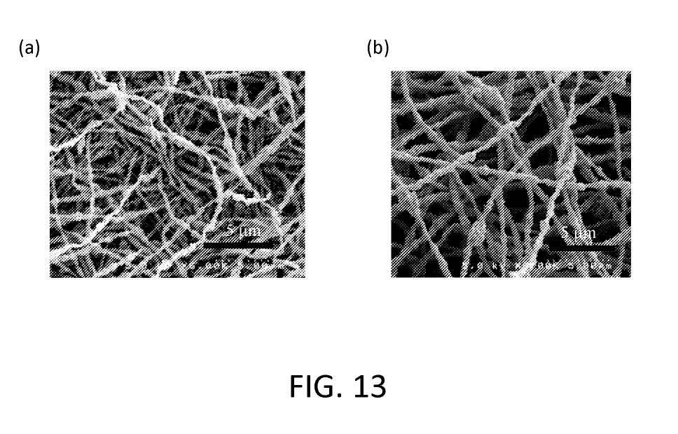

FIG. 13 shows top-down 6,000× SEM images of an electrospun Pt/C/Nafion/PAA nanofiber mat with an average fiber diamter of (a) 250 nm and (b) 475 nm according to certain embodiments of the present invention, where the Pt/C catalyst used was TKK Pt/HSAC. FIG. 13(a) is a mat with an average fiber diameter of 250 nm whereas the average fiber diameter of the mat as shown in FIG. 13(a) is 475 nm. For better imaging, the mats were lightly pressed at room temperature onto conductive SEM tape and sputter coated with a thin layer of gold. In both figures, the general shape (a generally uniform diameter along the length of a fiber) and features (i.e., roughened surface) are the same.

TABLE 2
Electrospinning Conditions for Fiber Diameter Control of
Pt/C/Nafion/PAA Nanofiber Electrodes with TKK Pt/HSAC
catalyst

| Avg. Diameter | | | Power at 0.65 V |
|---|---|---|---|
| (nm) | Solvent | Ink Solids % | (mW/cm²) |
| 250 | n-propanol/water | 10 | 444 |
| 330 | isopropanol/water | 10 | 462 |
| 380 | isopropanol/water | 12 | 433 |
| 475 | ethanol/water | 15 | 475 |
| 485 | ethanol/water | 18 | 465 |
| 520 | methanol/water | 15 | 489 |

The effect of nanofiber diameter (for both the anode and cathode) on fuel cell performance is shown in Table 2, where the power output at 0.65 V is listed for cathodes with an average fiber diameter in the range of 250-520 nm. There was no clear correlation between power output and average fiber diameter and the measured power density at 0.65 V was 460 mW/cm²±7% for all of the cathodes. This observation was not entirely unexpected; due to porosity within the fibers themselves and a uniform distribution/mixing of binder and catalyst particles, there is excellent interfacial contact of O₂ and Pt sites. Thus, the characteristic diffusion path length for oxygen reactant is not the fiber diameter, but rather the thickness of the binder coating on a given catalyst particle. Additionally, there was no fundamental difference in the shape of the fuel cell polarization curves with fiber diameter at high current densities, which indicates that inter-fiber porosity was providing for the rapid expulsion of product water.

### Performance and Durability Evaluation

The MEA durability tests were performed at NTCNA using 25 cm² MEAs. Nanofiber MEAs were made from catalyst-coated membranes (CCMs) with nanofiber cathodes and anodes that were fabricated at Vanderbilt University. These electrodes had a fixed Pt/C:Nafion:PAA wt. ratio of 72:13:15 and an average fiber diameter of ˜400 nm. All MEAs were prepared with JM Pt/Vulcan catalyst cathodes and anodes, where the Pt loading of each electrode was 0.10±0.005 mg/cm².

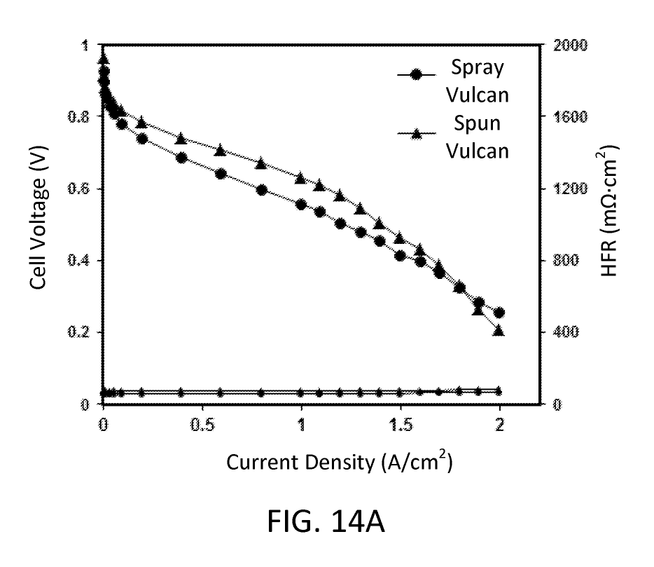

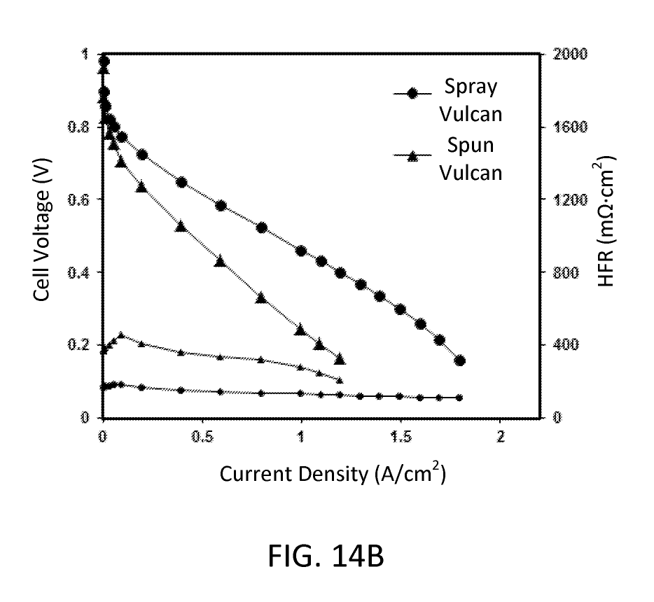

FIGS. 14A and 14B schematically show the effect of electrode structure on MEA performance with JM Pt/Vulcan catalyst using nanofiber electrode MEA and traditonal spray-coated MEA according to certain embodiments of the present invention, where FIG. 14A is at 100% RH, and FIG. 14B is at 40% RH. All data as shown in FIGS. 14A and 14B is recorded at 1 bar_{g} pressure in air/H₂ at 80° C. with NR211 membrane. As shown in the figures, the nanofiber MEA exhibited better performance than the spray-coated MEA under 100% RH condition (see FIG. 14A). This advantage in power densities can be partially attributed to an increase in active catalyst sites and faster electrode kinetics as shown in Table 3, where the ECA and catalytic mass activity of the electrospun fiber cathode is 28-50% greater than the spray-coated Johnson-Matthey catalyst material.

TABLE 3
Electrochemical Surface Area, Specific Current Density, and
Mass Activity for MEAs with Electrospun or Sprayed Electrodes
with JM Pt/Vulcan Catalyst Cathodes (measurements taken at
100% RH, determined in O₂ at 1 bar_{g})

| | | Specific Current | |
|---|---|---|---|
| | ECA | Density | Mass Activity |
| Electrode Type | (m²/g_{Pt}) | (mA/cm²_{Pt}) | (mA/mg_{Pt}) |
| Electrospun JM Pt/Vulcan | 64 | 318 | 203 |
| Sprayed JM Pt/Vulcan | 50 | 89 | 44 |

The improved performance of the nanofiber cathode is associated with an improvement in the accessibility of air/oxygen to Pt catalyst sites due to a thinner binder (Nafion+PAA) layer covering the catalyst particles and thus, better reactant mass transfer in the electrospun structure. The high sheer stresses at the spinneret tip during nanofiber electrospinning and the elongation of the fiber as it travels from the spinneret to the collector surface during the electrospinning process effectively mixes binder and catalyst and then causes a thinning of the binder coating on catalyst particles. Thus, there is a more uniform distribution of binder and catalyst in the nanofibers with little/no catalyst particle agglomeration.

Under low RH conditions, however, the spray-coated MEA showed significantly better performance than the nanofiber MEA, as shown in FIG. 14b. This finding is attributed to nanofiber dehydration at the low RH and high gas flow rates used in these experiments. There appears to be rapid water expulsion from the electrospun cathode due to the combined effects of a small average fiber diameter and significant interfiber porosity throughout the entire electrode. The high HFR values support this hypothesis. It should be noted that fuel cell tests were performed at very high feed gas flow rates (8 NLPM at the cathode and 4 NLPM at the anode) which might not be optimal for nanofiber MEA operation at low humidity. Since the present study was focused on examining the effect of electrode morphology on durability, there was no attempt to find the feed gas flow rate conditions that minimized fiber dehydration. The durability of nanofiber and spray-coated MEAs with JM Pt/Vulcan catalyst was evaluated under automotive-specific start-stop voltage cycling tests, as described in the experimental section.

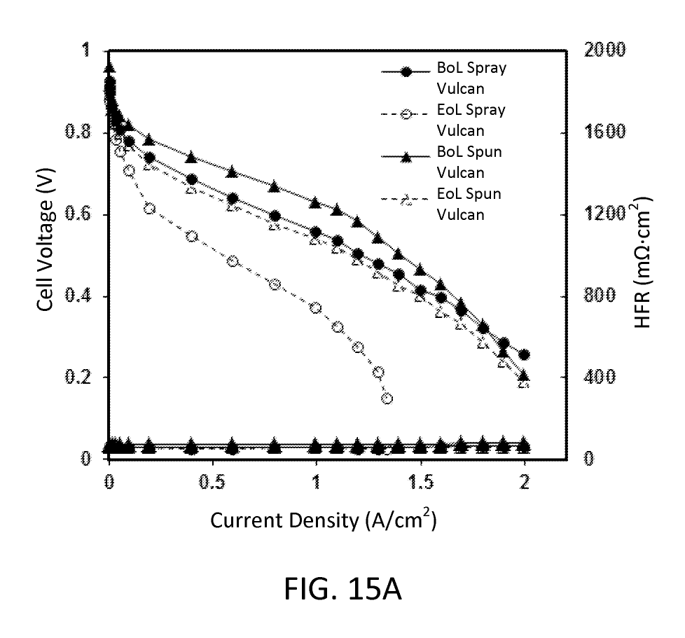

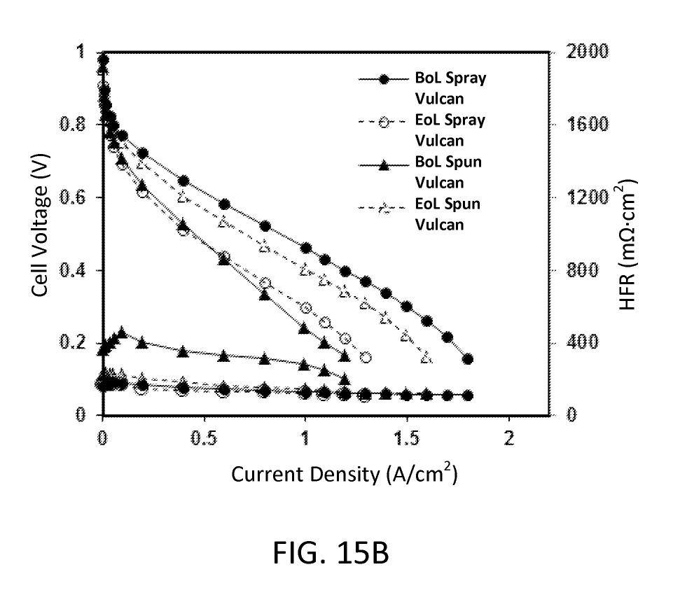

FIGS. 15A and 15B schematically show the effect of electrode structure on MEA durability showing nanofiber electrospun and traditonal spray-coated MEAs using JM Pt/Vulcan catalyst according to certain embodiments of the present invention, where FIG. 15A is at 100% RH, and FIG. 15B is at 40% RH. As shown in FIG. 15A for 100% RH operation, the spray-coated MEA showed severe performance losses due to carbon corrosion, significantly more than the nanofiber electrode. The EoL performance for the nanofiber electrode MEA was close to the BoL performance of the conventional spray-coated MEA, indicating excellent carbon corrosion resistance for the nanofiber morphology. The sprayed electrode results are consistent with prior studies, where start-stop potential cycling resulted in , carbon support corrosion leading to electrode thinning, Pt loss (detachment of Pt particles), and significant electrode structure degradation, leading to drastic power output performance losses. The carbon support also becomes more hydrophilic and retains more water, resulting in an increase in oxygen mass transport resistance.

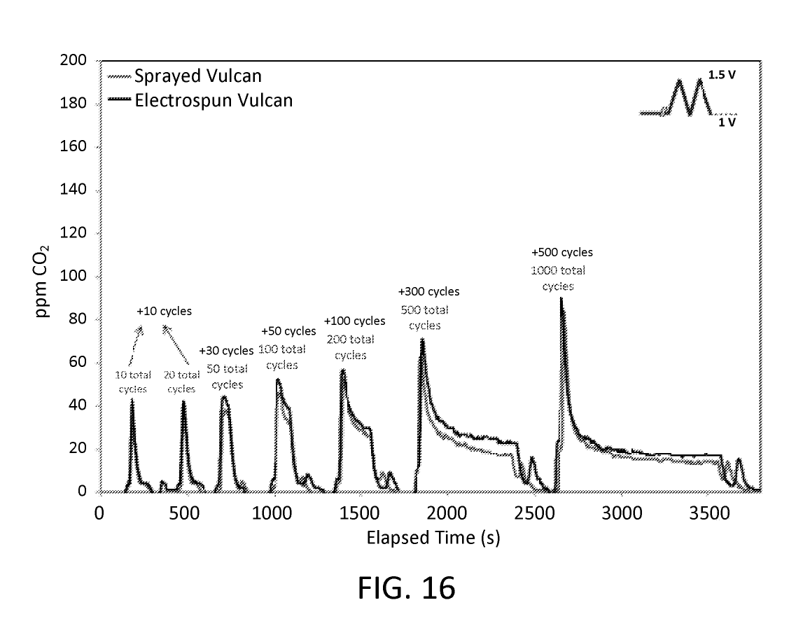

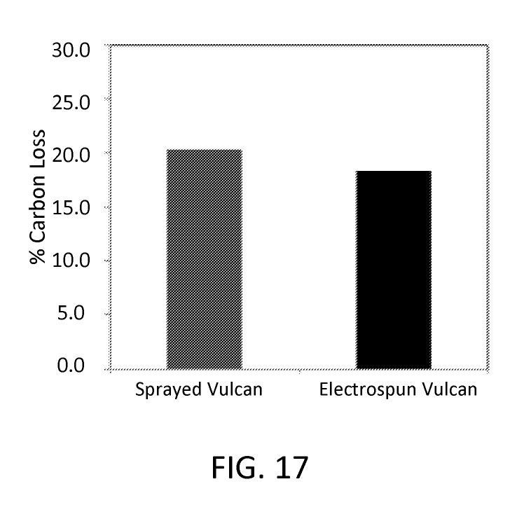

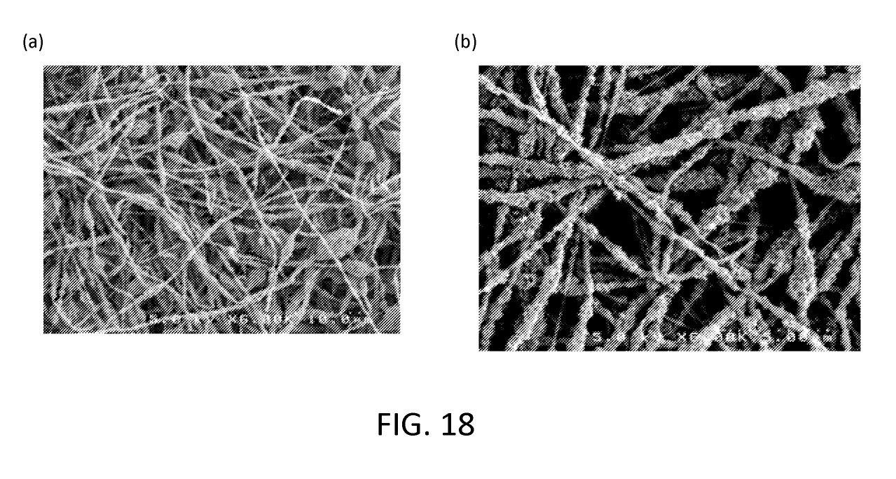

FIG. 16 schematically shows real time measurement of ppm CO₂ at the cathode exhaust during start-stop potential cycling (100% RH condition) of nanofiber electrode and traditional spray-coated MEAs using JM Pt/Vulcan catalyst according to certain embodiments of the present invention, and FIG. 17 schematically shows carbon loss calculated from data as shown in FIG. 16 according to certain embodiments of the present invention. Specifically, FIG. 16 shows the amount of CO₂ detected as a function of time during carbon corrosion tests with the two different MEAs. For both MEAs, CO₂ generation increased with the number of potential cycles, illustrating the aggressive nature of this particular accelerated stress test. As reported in the literature, repeated potential cycling has been found to be more aggressive than fixed potential hold durability tests [11].

As shown in FIG. 17, the normalized carbon loss was essentially the same for the sprayed and electrospun JM Pt/Vulcan catalyst cathodes (20% and 18%, respectively). This result strongly suggests that the mechanism for carbon corrosion is the same for the two MEA electrode morphologies. Additionally, both MEAs underwent a similar BoL to EoL loss in ECA of ˜40%, ending at 29 m²/g_{Pt} for the sprayed cathode vs. 40 m²/g_{Pt} for the nanofiber structure (the electrospun electrode started with a higher ECA and maintained its area advantage of the sprayed cathode at its EoL).

The superior EoL performance of the nanofiber MEA at full humidity has been attributed to the combined effects of a higher ECA and the unique morphology of the nanofiber mats (inter and intra fiber porosity) that allows for the rapid expulsion of product water, thus preventing flooding. SEMs have confirmed that the nanofiber structure remains intact at EoL. The drop in 100% RH performance for the spray-coated MEA , on the other hand, is associated with a loss in ECA and water flooding due to an increase in the hydrophilicity of the carbon support (i.e., the formation of C═O and other surface moieties that hold onto water). The performance losses for either MEA are not due to an increase in ohmic resistance, as the HFR remained unchanged for both spun and sprayed electrode MEAs at 100% RH.

The nanofibers also become more hydrophilic, but the structure still allows easier removal of water, allowing easier oxygen access to Pt sites.

The performance of the nanofiber MEA is even more impressive after voltage cycling when the power output was measured at 40% RH feed gas conditions. Here, the performance of the electrospun MEAs actually improved after the carbon corrosion test. Its EoL performance was significantly better than its BoL performance, even though there was a 20% carbon mass loss (as measured by CO₂). Now carbon support oxidation was making the nanofibers more hydrophilic (better water retention properties) and less prone to drying during fuel cell operation at low RH and high feed gas flow rates. On the other hand, the spray-coated MEA showed the same (expected) drop in EoL performance as was observed in the 100% RH polarization curve. The hypothesis of better catalyst/binder hydration with the nanofiber electrode is supported by a decrease in EoL HFR of the electrospun electrode as compared to the BoL HFR. It should be noted that the unusual nanofiber corrosion test results at low RH are reproducible, as confirmed by repeated tests with identical MEAs.

Durability experiments were also carried with TKK Pt/HSAC nanofiber and sprayed electrode MEAs at 0.1 mg_{Pt}/cm². The EoL results were qualitatively similar to those found with the JM Pt/Vulcan catalyst for both the electrospun MEAs. (e.g., the power output at EoL was greater than the BoL iV curve for 40% RH), but the sprayed TKK Pt/HSAC MEA showed much more severe flooding effects and a more dramatic loss in power output at EoL. A summary of BoL and EoL MEA performance at 100% RH is presented in Table 4 for sprayed and electrospun electrodes JM and TKK catalysts.

TABLE 4
BoL and EoL MEA Performance for a Start-Stop Carbon
Corrosion Voltage Cycling Experiment. at 80° C. and
100% RH

| | Electrode | Power at 0.65 V | Max Power |
|---|---|---|---|
| Catalyst | Structure | EoL/BoL | Eol/BoL |
| JM Pt/Vulcan | Spun | 0.53 | 0.85 |
| JM Pt/Vulcan | Spray | 0.28 | 0.59 |
| TKK Pt/HSAC | Spun | 0.58 | 0.83 |
| TKK Pt/HSAC | Spray | 0.29 | 0.18 |

Effect of Load cycling on iV performance: The Pt active area/ECA can drop significantly under the load cycle protocol shown in FIG. 9 due to Pt dissolution, redistribution, and agglomeration but the effect of these cathode changes on iV performance is not particularly significant. Nonetheless, to be thorough, MEA load cycling durability tests were performed with electrospun nanofiber or sprayed droplet electrodes. The results (not shown here) showed that MEA performance with both electrode architectures with either JM/Vulcan or TKK/HSAC catalyst were essentially the same, as quantified by the measured EoL vs. BoL ECA losses and changes in iV performance plots. Thus, it can be concluded that, unlike start-stop cycling, no effect of electrode structure was observed on MEA durability under the load cycling protocol.

As discussed above, these experiments show that electrospinning is a robust and effective technique for creating nanofiber fuel cell electrode morphology. TKK TEC10E50E catalyst (Pt/HSAC) performed similarly as JM Pt/Vulcan in a nanofiber electrode MEA. The performance of electrospun nanofiber MEAs with TKK was insensitive to changes in the fiber ionomer content (Nafion 13-30 wt. %). Fuel cell performance with TKK TEC10E50E did not change significantly with average fiber diameter, in the range of 250-520 nm. Therefore, precise control of nanofiber electrode composition and fiber diameter is not required, which should ease industrial scale up and manufacturing.

It was found that the nanofiber MEA showed better performance than the spray-coated MEA under 100% RH condition. It is believed that the nanofiber structure provides more Pt catalyst active sites and these sites are more accessible to oxygen than in the case of traditional spray-coated electrodes, due presumably to a thinner binder (Nafion-PAA) layer covering the Pt catalyst particles. Under low RH conditions (40% RH), the electrospun electrodes showed significantly higher HFR and poor iV performance. The nanofiber structure may remove water faster than traditional spray-coated electrodes, resulting in sub-optimal catalyst layer hydration and/or drying effects under low RH test conditions.

Load cycling durability tests on both types of MEAs showed that the electrode structure does not have any significant impact on Pt dissolution durability. On the other hand, it was found that the nanofiber electrodes showed significantly better durability under the automotive start-stop potential cycling test compared to traditional spray-coated MEAs. Both types of MEA had comparable CO₂ formation data and overall carbon loss (˜20%), but the spray-coated MEA showed more significant performance loss than the electrospun MEA. The end-of-life (EoL) iV performance at 100%RH of the electrospun MEAs was significantly better than the spray-coated MEA and this is believed to be due to not having the flooding problems that the sprayed electrodes have after the carbon becomes more hydrophilic. The superior electrode characteristics of the nanofiber structure was even more apparent under 40% RH test conditions, where it was observed that the EoL performance of the nanofiber electrode improved and was significantly better than the BoL performance after the harsh start-stop potential cycling test even though the MEA had already lost 20% of its carbon mass. This is believed to be due to a more optimal water content/hydration in the nanofiber electrode due to the increased hydrophilicity/water retention of the carbon support after start-stop potential cycling at low RH conditions. Thus, nanofiber electrode MEAs showed both better initial power output and a less severe performance drop after start-stop durability cycling than traditional sprayed electrode MEAs.

### EXAMPLE THREE

In this example, nanofiber fuel cell electrodes were prepared with a polymer binder composed of Nafion and polyvinylidene fluoride, henceforth abbreviated as PVDF, or with just PVDF. Nanofiber mat electrodes were incorporated into membrane electrode assemblies (MEAs) and tested in a hydrogen/air fuel cell. Experimental details follow.

### Preparing Inks and Electrospinning Fibers

Electrospinning inks with Nafion/PVDF binder were prepared by mixing in a DMF/THF/acetone solvent: (a) Johnson Matthey Company HiSpec™ 4000 (40% Pt on Vulcan carbon), (b) Nafion® ion exchange resin, and (c) and Kynar HSV 900 polyvinylidene fluoride. A suspension of Nafion and catalyst was first sonicated for 90 minutes with intermittent mechanical stirring before the addition of PVDF. The entire mixture was then mechanically stirred for approximately 15 hours. The total polymer and powder content of the spinning suspensions was between 10-18 wt %, and the Pt/C:Nafion:PVDF weight ratio was varied so the a dry mat contained 70 wt % Pt/C, 10-26 wt % Nafion and 4-20 wt % PVDF.

Electrospinning inks with PVDF binder (no Nafion) were prepared by mixing in a DMF/acetone solvent: (a) Johnson Matthey Company HiSpec™ 4000 (40% Pt on Vulcan carbon) and (c) and Kynar HSV 900 polyvinylidene fluoride. A suspension of catalyst was first sonicated for 90 minutes with intermittent mechanical stirring before the addition of PVDF. The entire mixture was then mechanically stirred for approximately 15 hours. The total polymer and powder content of the spinning suspensions was 10 wt %, and the Pt/C:PVDF weight ratio of a dry mat contained 70 wt % Pt/C, and 30 wt % PVDF.

The inks were drawn into a 3 mL syringe and electrospun using a 22-gauge stainless steel needle spinneret, where the needle tip was polarized to a potential of 12-16 kV relative to a grounded stainless steel rotating drum collector that was operated at a rotation speed of 100 rpm. The spinneret-to-collector distance was fixed at 10 cm and the flow rate of ink was held constant for all experiments at 1.0 mL/h. Nanofibers were collected on aluminum foil that was attached to the cylindrical collector drum. The drum also oscillated horizontally to improve the uniformity of deposited nanofibers. Electrospinning was performed at room temperature in a custom-built environmental chamber, where the relative humidity was maintained at 30-70%. FIG. 18 schematically shows top-down 6,000× SEM image of an electrospun fiber mat with Pt/C catalyst particles with a binder of (a) Nafion+PVDF and (b) PVDF according to certain embodiments of the present invention. For FIG. 18(a), the fiber composition is: 70 wt % catalyst, 20 wt % Nafion, 10 wt % PVDF. For FIG. 18(b), the fiber composition is: 70 wt % catalyst, 30 wt % PVDF.

### Membrane-Electrode-Assembly (MEA) Preparation

MEAs were created by hot pressing 5 cm² electrospun electrodes (anode and cathode) onto the opposing sides of a Nafion 211 membrane at 140° C. and 4 MPa for 1 minute, after a 10-minute heating period at 140° C. and 0 MPa. The Pt loading of a nanofiber mat was calculated from its total electrode weight and the weight-fraction of Pt/C catalyst used in the electrospinning ink. A 5 cm² carbon gas diffusion layer (Sigracet GDL 25 BCH) was physically pressed onto the MEA's anode and cathode when the MEA was placed in the fuel cell test fixture. For comparison purposes, 5 cm² MEAS were also prepared with a traditional painted gas diffusion electrodes (GDEs) with only Nafion as the catalyst binder and a N211 membrane, where the catalyst typed and anode/cathode loadings were the same as electrospun electrode MEAs.

### MEA Performance Results

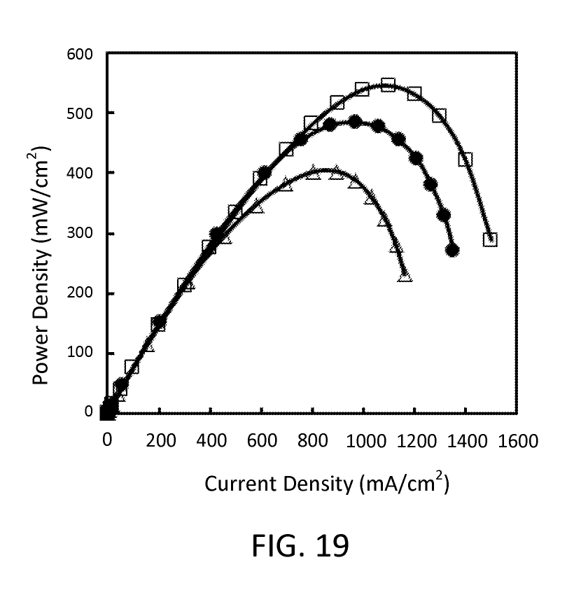

FIG. 19 schematically shows power density vs. current density curves for 5 cm² MEAs with a Nafion 211 membrane and cathode and anode Pt loading of 0.10 mg/cm² with Johnson Matthey HiSpec 4000 catalyst according to certain embodiments of the present invention. Specifically, the power densities of an MEA with an electrospun Nafion/PVDF binder cathode is shown in FIG. 19. Fuel cell operating conditions are: 80° C., 100% RH feed gases at ambient pressure, 125 sccm H₂ and 500 sccm air. Electrode compositions in FIG. 19 are: (□) Cathode—Electrospun, Catalyst:Nafion:PVDF at 70:24:6 wt %; Anode—Electrospun, Catalyst:Nafion:PAA at 65:23:12 wt %:, () Cathode—Electrospun, Catalyst:Nafion:PAA at 72:13:15 wt %; Anode—Electrospun, Catalyst:Nafion:PAA at 72:13:15 wt % (A) Cathode—Painted GDE, at Catalyst:Nafion 77:23 wt %; Anode—Painted

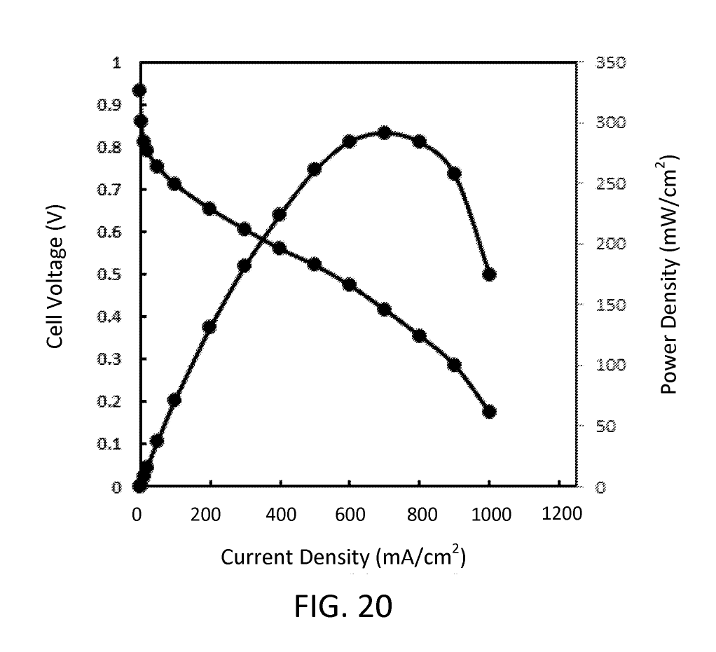

GDE, at Catalyst:Nafion 77:23 wt % (GDE deonte gas diffusion electrode). The new results are contrasted with an MEA with a electrospun Nafion/poly(acrylic acid) (PAA) cathode and a traditional painted non-structured gas diffusion electrode with a Nafion binder. For all MEAs, the Pt loading of the anode and cathode were the same, at 0.10 mg/cm². The maximum power of the MEA with the electrospun Nafion/PVDF bound cathode was 545 mW/cm², compared to 484 mW/cm² for the electropusn Nafion/PAA and 403 mW/cm² for the painted GDE. FIG. 20 schematically shows power density and polarization curves for a 5 cm² MEA with a Nafion 211 membrane and a nanofiber cathode and anode according to certain embodiments of the present invention. Specifically, the fuel cell performance of an MEA with an electrospun cathode with no Nafion (70 wt % catalyst and 30 wt % PVDF) is shown in FIG. 20. This MEA had a maximum power of 291 mW/cm². The Pt loading for each electrode was 0.10 mg/cm² with Johnson Matthey HiSpec 4000 catalyst. Fuel cell operating conditions: 80° C., 100% RH feed gases at ambient pressure, 125 sccm H₂ and 500 sccm air. Cathode nanofiber mat had a compositoin of 70 wt/ % Pt/C powder and 30 wt % PVDF. The nanofiber anode had a composition of 65 wt % Pt/C powder, 23 wt % Nafion, and 12 wt % PAA.

The foregoing description of the exemplary embodiments of the invention has been presented only for the purposes of illustration and description and is not intended to be exhaustive or to limit the invention to the precise forms disclosed. Many modifications and variations are possible in light of the above teaching.

The embodiments were chosen and described in order to explain the principles of the invention and their practical application so as to enable others skilled in the art to utilize the invention and various embodiments and with various modifications as are suited to the particular use contemplated. Alternative embodiments will become apparent to those skilled in the art to which the present invention pertains without departing from its spirit and scope. Accordingly, the scope of the present invention is defined by the appended claims rather than the foregoing description and the exemplary embodiments described therein.

### LISTING OF REFERENCES

[1]. C. G. Arges, The Electrochemical Society Interface, 19, 31 (2010).
[2]. M. R. Hibbs, M. A. Hickner, T. M. Alam, S. K. McIntyre, C. H. Fujimoto and C. J. Cornelius, Chem Mater, 20, 2566 (2008).
[3]. D. P. Tang, J. Pan, S. F. Lu, L. Zhuang and J. T. Lu, Sci. China-Chem., 53, 357 (2010).
[4]. J. B. Ballengee and P. N. Pintauro, Macromolecules, 44, 7307 (2011).
[5]. W. J. Zhang and P. N. Pintauro, Chemsuschem, 4, 1753 (2011).
[6]. S. Petrik and M. Maly, Production Nozzle-Less Electrospinning Nanofiber Technology, http://www.elmarco.com/upload/soubory/dokumenty/66-1-1-mrs-fall-boston-09. pdf
[7]. http://fiberiotech.com/
[8] J. B. Ballengee and P. N. Pintauro, Journal of the Electrochemical Society, 158, B568-B572 (2011).
[9] E. Niangar, T. Han, N. Dale, and K. Adjemian, ECS Transactions, 50, 1599-1606 (2013).
[10] K.-H. Kim, K.-Y. Lee, H.-J. Kim, E. Cho, S.-Y. Lee, T.-H. Lim, S. P. Yoon, I. C. Hwang, and J. H. Jang, International Journal of Hydrogen Energy, 35, 2119-2126 (2010).
[11] Y. Shao, J. Wang, R. Kou, M. Engelhard, J. Liu, Y. Wang, and Y. Lin, Electrochimica Acta, 54, 3109-3114 (2009).

What is claimed is:

1. An article of manufacture, comprising:
a fiber mat, comprising at least one type of fibers, wherein the at least one type of fibers comprises one or more polymers.

2. The article of claim 1, wherein the fiber mat is a single fiber mat comprising one type of fibers, wherein the one type of fibers comprises the one or more polymers.

3. The article of claim 2, wherein the one type of fibers further comprises a plurality of particles of a catalyst.

4. The article of claim 3, wherein the catalyst comprises platinum (Pt) particles, Pt alloy particles, Pt on carbon particles, precious metal particles, precious metal on carbon particles, precious metal based alloys, precious metal based alloys on carbon particles, silver (Ag) particles, nickel (Ni) particles, Ag alloy particles, Ni alloy particles, iron (Fe) particles, Fe alloy particles, palladium (Pd) particles, Pd alloy particles, core-shell catalyst particles, non-platinum group metal (PGM) fuel cell catalysts, or a combination thereof.

5. The article of claim 3, wherein at least one of the one or more polymers serves as a polymer binder.

6. The article of claim 5, wherein the polymer binder comprises at least one of Nafion and polyvinylidene fluoride (PVDF).

7. The article of claim 3, wherein the fiber mat is used to form an electrode.

8. The article of claim 7, wherein the electrode is an anode electrode or a cathode electrode.

9. The article of claim 1, wherein the fiber mat is a dual or multi fiber mat comprising a plurality of types of fibers, wherein each of the plurality of types of fibers comprises the one or more polymers.

10. The article of claim 9, wherein each of the plurality of types of fibers comprises a first polymer and a second polymer, and has a different ratio of the first polymer and the second polymer.

11. The article of claim 9, wherein at least one of the plurality of types of fibers comprises a polymer not in another of the plurality of types of fibers.

12. The article of claim 9, wherein at least one of the plurality of types of fibers further comprises a plurality of particles of a catalyst.

13. The article of claim 12, wherein the catalyst comprises platinum (Pt) particles, Pt alloy particles, Pt on carbon particles, precious metal particles, precious metal on carbon particles, precious metal based alloys, precious metal based alloys on carbon particles, silver (Ag) particles, nickel (Ni) particles, Ag alloy particles, Ni alloy particles, iron (Fe) particles, Fe alloy particles, palladium (Pd) particles, Pd alloy particles, core-shell catalyst particles, non-platinum group metal (PGM) fuel cell catalysts, or a combination thereof.

14. The article of claim 12, wherein in the at least one of the plurality of types of fibers comprising the plurality of particles of the catalyst, at least one of the one or more polymers serves as a polymer binder.

15. The article of claim 14, wherein the polymer binder comprises at least one of Nafion and polyvinylidene fluoride (PVDF).

16. The article of claim 9, wherein the fiber mat is used to form an electrode.

17. The article of claim 16, wherein the electrode is an anode electrode or a cathode electrode.

18. The article of claim 1, wherein the fiber mat is used to form an ion exchange membrane.

19. The article of claim 18, wherein the ion exchange membrane is a cation exchange membrane or an anion exchange membrane.

20. The article of claim 1, wherein the fiber mat is usable in an electrochemical device.

21. The article of claim 20, wherein the electrochemical device is a fuel cell membrane-electrode-assembly (MEA).

22. An electrode, comprising:
a fiber mat, comprising at least one type of fibers, wherein the at least one type of fibers comprises one or more polymers, and a plurality of particles of a catalyst.

23. The electrode of claim 22, being an anode electrode or a cathode electrode.

24. The electrode of claim 22, wherein the catalyst comprises platinum (Pt) particles, Pt alloy particles, Pt on carbon particles, precious metal particles, precious metal on carbon particles, precious metal based alloys, precious metal based alloys on carbon particles, silver (Ag) particles, nickel (Ni) particles, Ag alloy particles, Ni alloy particles, iron (Fe) particles, Fe alloy particles, palladium (Pd) particles, Pd alloy particles, core-shell catalyst particles, non-platinum group metal (PGM) fuel cell catalysts, or a combination thereof.

25. The electrode of claim 22, wherein at least one of the one or more polymers serves as a polymer binder.

26. The electrode of claim 25, wherein the polymer binder comprises at least one of Nafion and polyvinylidene fluoride (PVDF).

27. The electrode of claim 22, wherein the fiber mat is a single fiber mat comprising one type of fibers, wherein the one type of fibers comprises the one or more polymers and the plurality of particles of the catalyst.

28. The electrode of claim 22, wherein the fiber mat is a dual or multi fiber mat, comprising a plurality of types of fibers, wherein each of the plurality of types of fibers comprises the one or more polymers, and at least one of the plurality of types fibers comprises the plurality of particles of the catalyst.

29. The electrode of claim 28, wherein in the at least one of the plurality of types of fibers comprising the plurality of particles of the catalyst, at least one of the one or more polymers serves as a polymer binder.

30. The electrode of claim 29, wherein the polymer binder comprises at least one of Nafion and polyvinylidene fluoride (PVDF).

31. The electrode of claim 28, wherein each of the plurality of types of fibers comprises a first polymer and a second polymer, and has a different ratio of the first polymer and the second polymer.

32. The electrode of claim 28, wherein at least one of the plurality of types of fibers comprises a polymer not in another of the plurality of types of fibers.

33. A membrane, comprising:
a fiber mat, comprising at least one type of fibers, wherein the at least one type of fibers comprises one or more polymers.

34. The membrane of claim 33, being an ion exchange membrane.

35. The membrane of claim 34, wherein the ion exchange membrane is a cation exchange membrane or an anion exchange membrane.

36. The membrane of claim 33, wherein the fiber mat is a single fiber mat comprising one type of fibers, wherein the one type of fibers comprises the one or more polymers.

37. The membrane of claim 33, wherein the fiber mat is a dual or multi fiber mat, comprising a plurality of types of fibers, wherein each of the plurality of types of fibers comprises the one or more polymers.

38. The membrane of claim 37, wherein each of the plurality of types of fibers comprises a first polymer and a second polymer, and has a different ratio of the first polymer and the second polymer.

39. The membrane of claim 37, wherein at least one of the plurality of types of fibers comprises a polymer not in another of the plurality of types of fibers.

40. The membrane of claim 37, wherein at least one of the plurality of types of fibers is configured to melt to fill in a space between the other of the plurality of types of fibers.

41. A fuel cell membrane-electrode-assembly (MEA), comprising:
an anode electrode formed by a first fiber mat;
a cathode electrode formed by a second fiber mat; and
a membrane formed by a third fiber mat, and disposed between the anode electrode and the cathode electrode,
wherein each of the first fiber mat, the second fiber mat and the third fiber mat comprises at least one type of fibers, wherein the at least one type of fibers comprises one or more polymers; and
wherein each of the first fiber mat and the second fiber mat further comprises a plurality of particles of a catalyst.

42. The fuel cell MEA of claim 41, wherein the membrane is an ion exchange membrane.

43. The fuel cell MEA of claim 42, wherein the ion exchange membrane is a cation exchange membrane or an anion exchange membrane.

44. The fuel cell MEA of claim 41, wherein at least one of the first fiber mat, the second fiber mat and the third fiber mat is a single fiber mat comprising one type of fibers.

45. The fuel cell MEA of claim 41, wherein at least one of the first fiber mat, the second fiber mat and the third fiber mat is a dual or multi fiber mat comprising a plurality of types of fibers.

46. The fuel cell MEA of claim 45, wherein each of the plurality of types of fibers comprises a first polymer and a second polymer, and has a different ratio of the first polymer and the second polymer.

47. The fuel cell MEA of claim 45, wherein at least one of the plurality of types of fibers comprises a polymer not in another of the plurality of types of fibers.

48. The fuel cell MEA of claim 41, wherein in each of the first fiber mat and the second fiber mat, one of the one or more polymers serves as a polymer binder.

49. The fuel cell MEA of claim 48, wherein the polymer binder comprises at least one of Nafion and polyvinylidene fluoride (PVDF).

50. An electrochemical device, comprising one or more fuel cell MEAs of claim 41.
